(19) United States
(12) Patent Application Publication
(10) Pub. No.: US 2026/0099333 A1
(43) Pub. Date: Apr. 9, 2026

(54) PROPAGATED SYNCHRONIZATION

(71) Applicant: Groq, Inc., San Jose, CA (US)

(72) Inventor: Matthew Thomas Boyd, Bend, OR (US)

(21) Appl. No.: 19/354,250

(22) Filed: Oct. 9, 2025

Related U.S. Application Data
(60) Provisional application No. 63/705,339, filed on Oct. 9, 2024.

(51) Int. Cl. G06F 9/38; G06F 9/52

(52) U.S. Cl. CPC G06F 9/3871; G06F 9/52

(57) ABSTRACT

A first partition of a distributed computing system can synchronously receive first data from a second partition of the distributed computing system. The first partition can execute one or more processor operations based at least in part on the first data to generate second data. The first partition can synchronously send the second data to a third partition of the distributed computing system. The one or more processor operations can be executed asynchronously with respect to at least one of the second partition and third partition.

### CROSS-REFERENCE TO PRIORITY APPLICATION

The present disclosure claims priority to U.S. Provisional Application Number 63,705,339, filed Oct. 9, 2024, the entirety of which is incorporated by reference herein.

### FIELD

The present disclosure relates generally to systems and methods for performing parallel computing operations.

### BACKGROUND

Parallel computing is a technique in which multiple computing devices or multiple processor devices can work together to perform a complex computation. For example, a computationally intensive computing task can be split into multiple subtasks that can be performed separately, and each subtask can be performed by a different computing device.

Parallel computing can require various kinds of coordination between computing devices, such as coordination to facilitate passing data between computing devices. For example, result data from a first subtask may be used as input to a second subtask performed by a different computing device, which may require the result data to be passed to the different computing device. Example computational tasks can include machine learning tasks, scientific computing simulation tasks, or other computationally intensive tasks.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include synchronously receiving, by first partition of a distributed computing system, first data from a second partition of the distributed computing system. The example method can include executing, by the first partition, one or more processor operations based at least in part on the first data to generate second data. The example method can include synchronously sending, by the first partition, the second data to a third partition of the distributed computing system. In the example method, the one or more processor operations can be executed asynchronously with respect to at least one of the second partition and third partition.

Example aspects of the present disclosure provide one or more example non-transitory computer-readable media storing instructions that are executable by one or more processors to cause a first synchronized partition of a computing system to perform example operations. In some implementations, the example operations can include synchronously receiving first data from a second partition of the computing system. The example operations can include executing one or more processor operations based at least in part on the first data to generate second data. The example operations can include synchronously sending the second data to a third partition of the computing system. In the example operations, the one or more processor operations can be executed asynchronously with respect to at least one of the second partition and third partition.

Example aspects of the present disclosure provide an example computing system that includes a plurality of synchronized partitions. In the example computing system, each synchronized partition can include a plurality of computing devices. The example computing system can include one or more non-transitory computer-readable media storing instructions that are executable by one or more processors to cause each respective partition of the plurality of synchronized partitions to perform operations. In some instances, the example operations can include, for each of one or more iterations, synchronously receiving, from a preceding synchronized partition of the computing system, operand data generated by the preceding synchronized partition. The example operations can include, for each of the one or more iterations, executing one or more processor operations based at least in part on the operand data to generate output data. The example operations can include, for each of the one or more iterations, synchronously transmitting, to a following synchronized partition of the computing system, the output data. In the example operations, the one or more processor operations can be executed asynchronously with respect to at least one of the preceding synchronized partition and the following synchronized partition.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1A is a block diagram of an example first state, at a first time, of a system for performing propagated synchronization according to example implementations of aspects of the present disclosure;

FIG. 1B is a block diagram of an example second state, at a second time, of the example system of FIG. 1A according to example implementations of aspects of the present disclosure;

FIG. 1C is a block diagram of an example third state, at a third time, of the example system of FIG. 1A according to example implementations of aspects of the present disclosure;

FIG. 2 is a sequence flow diagram of an example method for propagated synchronization according to example implementations of aspects of the present disclosure;

FIG. 3 is a block diagram of an example multi-rack computing system according to example implementations of aspects of the present disclosure;

FIG. 4 is a flow chart diagram of an example method for propagated synchronization according to example implementations of aspects of the present disclosure;

FIG. 5 is a block diagram of an example processor device according to example implementations of aspects of the present disclosure; and

FIG. 6 is a block diagram of an example system for performing machine-learning inference according to example implementations of aspects of the present disclosure.

### DETAILED DESCRIPTION

Example embodiments according to some aspects of the present disclosure are directed to systems and methods for propagated synchronization in a computing system comprising multiple computing devices. For example, a computing system can have a plurality of synchronized partitions, with each partition having one or more computing devices. Each synchronized partition can be connected to one or more neighboring partitions via one or more communication channels. Propagated synchronization can include, for example, various techniques for coordinating a multi-partition computing system based on temporary pairwise synchronizations between pairs of neighboring partitions. For example, a partition can temporarily synchronize with a first neighboring partition; synchronously receive input data from the first neighboring partition; asynchronously perform a computation based on the input data; and temporarily synchronize with a second neighboring partition to synchronously transmit output data.

As an illustrative example, a computing system can include a linear sequence of partitions, with each partition having one partition before it and one partition after it in the sequence. Continuing the illustrative example, a complex computational task can be split into a linear sequence of subtasks, each of which can be performed by one synchronized partition. Continuing the illustrative example, a first partition in the sequence can perform a first subtask; then temporarily synchronize with a second partition in the sequence; and then synchronously pass a result from the first subtask to the second partition. The second partition can temporarily synchronize with the first partition; synchronously receive the first result data; asynchronously perform a second subtask; temporarily synchronize with a third partition in the sequence; and synchronously pass a second result of the second subtask to the third partition. This can be continued, for example, through the linear sequence of partitions and subtasks, with each partition in the sequence temporarily synchronizing with a preceding partition to synchronously receive an input; asynchronously performing a subtask based on the input; and temporarily synchronizing with a following partition to synchronously transmit the output to the next partition. In this manner, for instance, a synchronous domain can propagate through the linear sequence of partitions, thereby providing synchronous communication throughout the linear sequence, without necessarily requiring complete synchronization of the entire sequence of partitions. This example is merely illustrative, and other examples (e.g., examples having non-linear communication topologies, etc.) are possible without deviating from the scope of the present disclosure.

In some instances, an operation performed using propagated synchronization can include a machine-learning operation, such as a machine-learning inference operation. For example, in some instances, a machine-learning model can include a plurality of layers arranged in a serial configuration, with each intermediate layer (sometimes referred to as a “hidden” layer) receiving input from one or more earlier layers and providing output to one or more later layers. In some instances, each partition of a plurality of partitions can be configured to implement one or more layers or other components (e.g., heads, etc.) of the machine-learning model to perform inference operations.

In some instances, a computing system can perform multiple operations in an “assembly line” style. For example, a partition can finish its subtask of a first computational task; pass its result data to a neighboring partition; and immediately receive new input data for its subtask of a second computational task, without necessarily waiting for the first computational task to proceed through an entire sequence of partitions. In some instances, a computing system can perform multiple repetitions of the “same” computational task (e.g., performing multiple inferences using the same machine-learning model based on different inputs, etc.) or different computational tasks. For example, in some instances, a plurality of inference operations using the same machine-learning model can be performed assembly-line-style, with each partition repeatedly executing the same component(s) (e.g., layer(s), head(s), etc.) of the machine-learning model on a plurality of different inputs. In some instances, each computing device of a partition can store one or more designated parameters of the machine-learning model in memory, and can reuse the parameters for multiple assembly-line-style operations, thereby reducing an overhead cost of loading parameters compared to some alternative implementations. As another example, in some instances, a partition can receive (e.g., from an earlier partition in a sequence; from a user or computing device requesting a particular operation) program identifier data indicative of a new subtask to be performed; and can load, based on the program identifier data, computer-executable instructions for performing the subtask.

In some instances, a computing system can include one or more deterministic processor devices. A deterministic processor can include, for example, a processor configured to deterministically execute operations in a program order determined at compile time by a compiler. In some instances, a deterministic processor can execute operations according to a predetermined timing determined at compile time by the compiler. In some instances, synchronous communication can include synchronous communication based on deterministic timing of the communication. For example, in some instances, a pair of neighboring partitions can temporarily synchronize with each other, and a sending partition can send a notification indicating a predetermined time (e.g., predetermined clock cycle, etc.) at which the sending partition will begin sending the data. After receiving the notification, the receiving partition can receive and process the data based at least in part on the predetermined time.

In some instances, a computing system can perform one or more asynchronous or nondeterministic input/output operations (e.g., instead of or in addition to synchronous or deterministic communication operations, etc.). For example, in some instances, a sequence of partitions can include an initial partition configured to receive inputs (e.g., inputs to an input layer of a machine-learning model, etc.) from a first non-deterministic input/output (I/O) system (e.g., peripheral component interconnect express (PCIe) system, etc.); an output partition configured to provide outputs (e.g., outputs from an output layer of the machine-learning model, etc.) to the first or a second non-deterministic I/O system; and one or more other partitions. As another example, in some instances, one or more intermediate partitions can be configured to perform non-deterministic I/O operations, such as non-deterministic reads or writes to an external memory device to cache a computational state of one or more computing operations. In some instances, a computing system that implements both deterministic communication and non-deterministic I/O operations can implement a “backpressure” mechanism, wherein a partition that is waiting on a non-deterministic I/O system can provide a signal to a preceding partition indicating that the waiting partition is not ready to receive input data.

In some instances, a subtask performed by an individual partition can include a parallel computing operation performed by a plurality of computing devices of the partition. For example, a multi-partition computing task can include a plurality of subtasks that are performed asynchronously and/or in series with respect to other subtasks and other partitions, but may be performed synchronously and/or in parallel within the subtask and within a partition performing the subtask. For example, a partition can include a synchronized partition having a plurality of computing devices, wherein each device is synchronized with each other device of the plurality of computing devices while a computation is being performed.

In some instances, synchronizing two computing devices or partitions can include passing one or more timing messages between the devices or partitions; and synchronizing based on the timing message(s). For example, a first device can send one or more messages indicating a current time according to the first device's system clock; and the second device can synchronize its own operations with the first device's operations based at least in part on the message(s) (e.g., and based on knowledge of latency properties of a communication link between the first and second devices, etc.). Synchronizing more than two devices can include, for example, performing multiple pairwise synchronizations, such as synchronizing a first device with a second device; then synchronizing the second device with a third device; synchronizing the first device with a fourth device; and so on.

Systems and methods according to some aspects of the present disclosure can provide a variety of technical effects and benefits, such as improvements to computing technology (e.g., distributed computing technology, machine-learning technology, etc.). For example, in some instances, systems and methods according to some aspects of the present disclosure can reduce a synchronization overhead of a distributed computing operation compared to some alternative implementations. As another example, in some instances, systems and methods according to some aspects of the present disclosure can reduce a latency or increase a throughput of some computational operations (e.g., machine-learning inference operations, etc.) compared to some alternative implementations. As another example, in some instances, systems and methods according to some aspects of the present disclosure can reduce a communication overhead of a distributed computing operation compared to some alternative implementations.

Other technical effects and benefits are possible (e.g., reduced overhead associated with parameter loading, etc.).

In some instances, systems and methods according to some aspects of the present disclosure can reduce a synchronization overhead of a distributed computing operation compared to some alternative implementations. For example, some alternative implementations may include implementations that may rely on larger-scale synchronization operations, such as implementations that may maintain synchronization between most or all computing devices of a computing system, or may maintain permanent synchronization between some computing devices. In such instances, larger-scale synchronization operations can increase a synchronization overhead by requiring a greater number of synchronization messages to be passed between computing devices; a greater number of timing adjustments to be performed based on the synchronization messages; and so on. In contrast, systems and methods according to some aspects of the present disclosure can reduce a scale of synchronization by providing temporary local synchronization operations only when synchronization is needed, thereby reducing a number of devices being synchronized at any given time, and reducing an amount of time the devices remain synchronized. Advantageously, systems and methods according to some aspects of the present disclosure can provide such reduced-scale synchronization even in instances where a “chain” of synchronization extends to most or all devices in the computing system. Reduced synchronization overhead can provide various additional benefits, such as increased hardware utilization (e.g., processor utilization, etc.) due to the reduced overhead (e.g., due to reduced time spent on synchronizing, etc.); reduced hardware costs (e.g., capital costs, etc.) due to increased hardware utilization; or other benefits.

In some instances, systems and methods according to some aspects of the present disclosure can reduce a latency or increase a throughput of some computational operations (e.g., machine-learning inference operations, etc.) compared to some alternative implementations. For example, in some instances, systems and methods according to some aspects of the present disclosure can provide deterministic-timing communication between deterministic processor devices. In some instances, deterministic communication can reduce latency in various ways, such as by directly reducing worst-case latency due to non-determinism; by providing for predictable timing of input data, which can in turn provide increased compiler control of computational timing, thereby providing a reduced-latency compiled program in some instances; or in another manner. As another example, systems and methods according to some aspects of the present disclosure can perform a plurality of low-latency computations in an assembly line style, thereby increasing a throughput of a plurality of computations compared to some alternative implementations (e.g., higher-latency implementations, non-assembly-line implementations, etc.).

In some instances, systems and methods according to some aspects of the present disclosure can reduce a communication overhead of a distributed computing operation compared to some alternative implementations. For example, in some instances, systems and methods according to some aspects of the present disclosure can provide deterministic-timing communication between deterministic processor devices. In some instances, deterministic-timing communication can provide for reduced communication overhead compared to some alternative implementations. For example, in some instances, deterministic communication may provide for communication with reduced overhead, such as reduced handshaking; reduced-size packet headers or data transmissions without packet headers; reduced retransmission or rerouting of transmitted data; or other communication overhead reductions.

With reference now to the Figures, example embodiments of the present disclosure will be discussed in further detail.

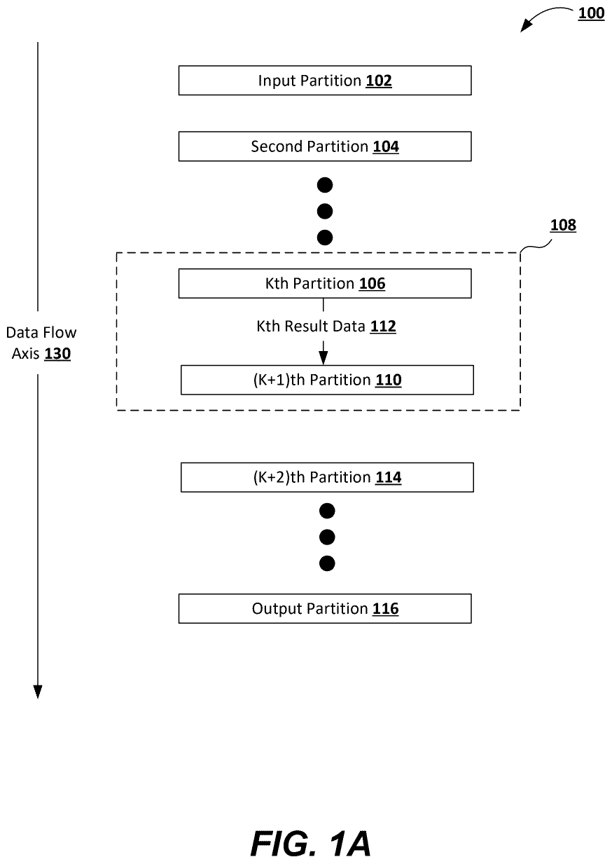

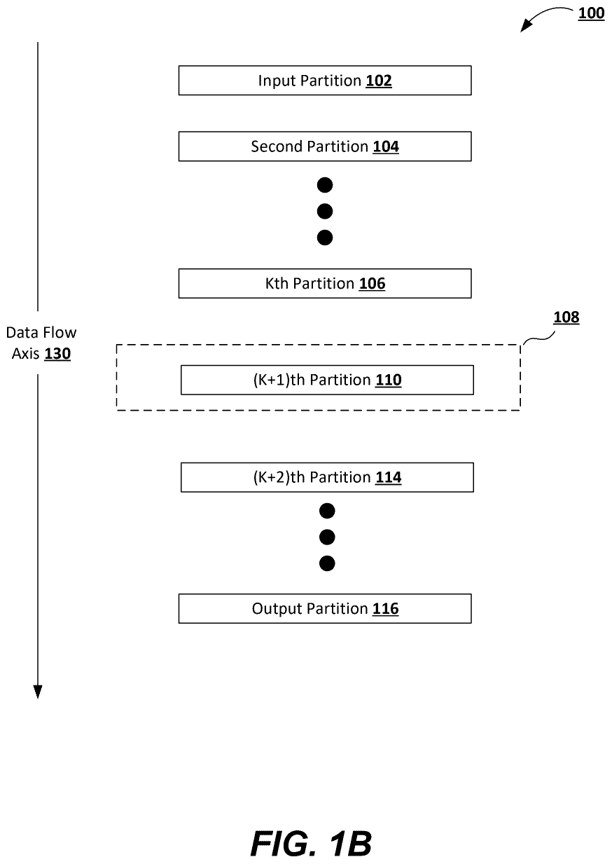

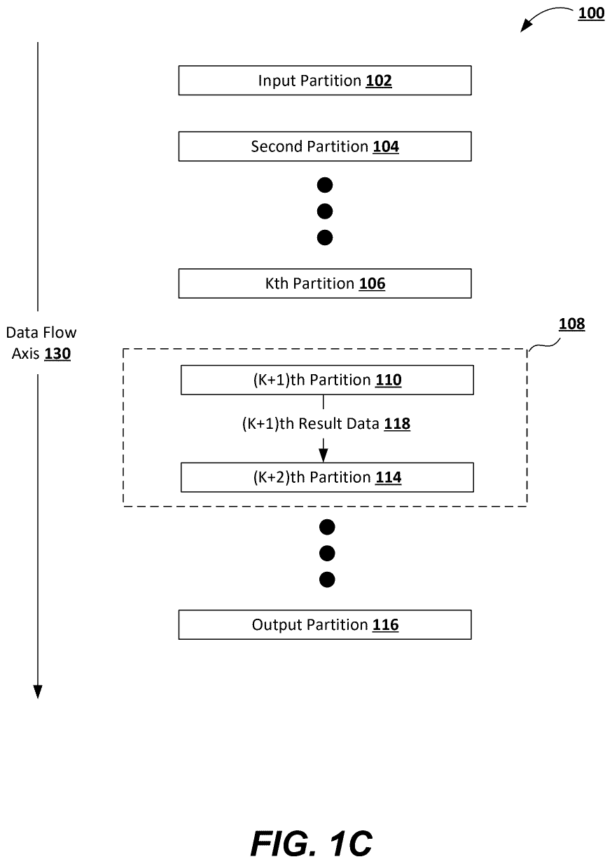

FIGS. 1A-1C are block diagrams of an example computing system 100 at three time segments of an example propagated synchronization operation according to example implementations of aspects of the present disclosure. The computing system 100 can include a plurality of partitions 102, 104, 106, 110, 114, 116, each comprising one or more computing devices. In some instances, one or more of the partitions 102, 104, 106, 110, 114, 116 can include a synchronized partition comprising a plurality of computing devices that are synchronized with each other. At a first time segment depicted in FIG. 1A, a synchronous domain 108 associated with the (K+1)th partition 110 can expand to include the Kth partition 106, such that the Kth partition 106 and (K+1)th partition 110 are synchronized with each other. The Kth partition 106 can synchronously transmit Kth result data 112 to the (K+1)th partition 110. At a second time segment depicted in FIG. 1B, the synchronous domain 108 of the (K+1)th partition 110 can contract to include only the (K+1)th partition, and the (K+1)th partition can perform one or more processor operations based on the Kth result data 112, which can be performed asynchronously with respect to neighboring partitions 106, 114. At a third time segment depicted in FIG. 1C, the synchronous domain 108 of the (K+1)th partition 110 can expand to include the (K+2)th partition, and the (K+1)th partition 110 can synchronously transmit (K+1)th result data 118 associated with the processor operation(s) to the (K+2)th partition 114.

In some instances, a computing system 100 can perform a propagated synchronization operation in which each of the plurality of partitions 102, 104, 106, 110, 114, 116 performs one or more operations similar to (e.g., same as, etc.) operations performed by the (K+1)th partition 110 in FIGS. 1A-1C. For example, an input partition 102 can receive input data; asynchronously generate first result data based on the input data; expand a synchronous domain to include the second partition 104; and synchronously transmit the first result data to the second partition 104. Continuing the example, the second partition 104 can expand a synchronous domain to include the input partition 102; synchronously receive the first result data; asynchronously (with respect to neighboring partitions) generate second result data based on the first data; expand the synchronous domain to include a third partition; and pass the second result data to the third partition. Continuing the example, a propagated synchronization operation can proceed, in the manner described above, through a sequence of operations until an output partition 116 is reached. An output partition 116 can, for example, expand a synchronous domain to include a prior partition; synchronously receive result data from the prior partition; generate output data based on the result data; and output the output data (e.g., to a human user, to a computing device, to a non-deterministic I/O system, etc.).

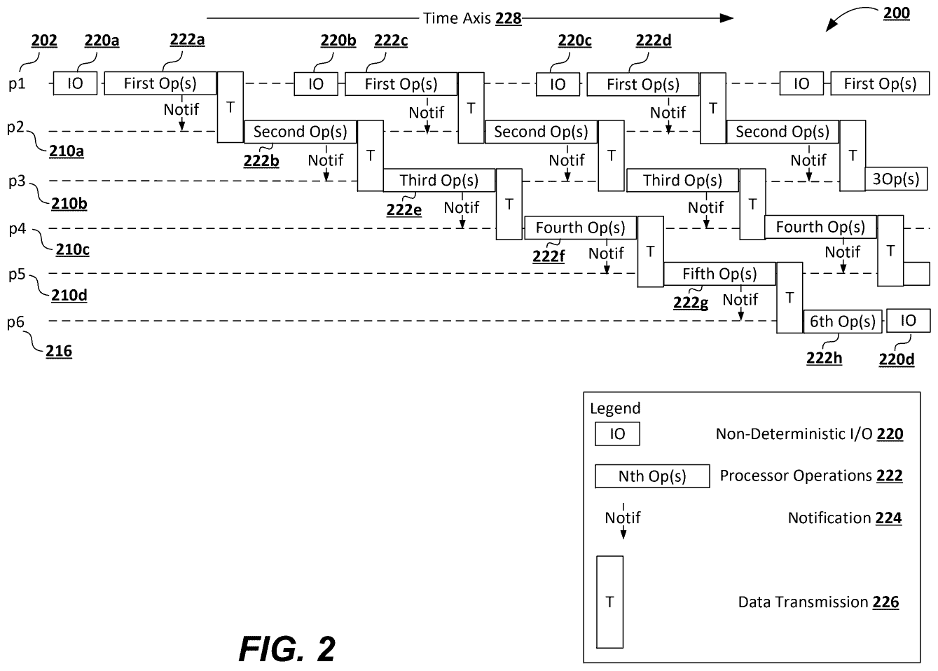

Synchronously receiving data can include, for example, one or more first devices receiving data from one or more second devices that are synchronized with the one or more first devices at a time the data is received. In some instances, synchronously receiving data can include receiving data based at least in part on shared timing data that is shared between synchronized devices, such as according to a synchronous communication protocol defining a timing (e.g., a time according to shared or synchronized timing data, such as a clock cycle according to synchronized clock cycle data, etc.) of one or more communications (e.g., data packets, etc.). Similarly, synchronously transmitting data can include one or more first devices transmitting data to one or more second devices that are synchronized with the one or more first devices at a time of transmission. In some instances, synchronously transmitting data can include transmitting data based at least in part on shared timing data that is shared between synchronized devices, such as according to a synchronous communication protocol defining a timing (e.g., a time according to shared or synchronized timing data, such as a clock cycle according to synchronized clock cycle data, etc.) of one or more communications (e.g., data packets, etc.). Further details of an example synchronous communication protocol are provided below with respect to FIG. 2 and some example notifications 224 and data transmissions 226.

In some instances, processor operations performed by a partition 102, 104, 106, 110, 114 can be performed asynchronously with respect to one or more neighboring partitions. In some instances, one or more first devices (e.g., a plurality of first devices of a first partition, etc.) executing processor operations that are asynchronous with respect to one or more second devices (e.g., a plurality of second devices of a neighboring partition, etc.) can include executing processor operations at a time when the first device(s) are not synchronized with the second device(s). In some instances, processor operations that are executed asynchronously with respect to one or more second device(s) can include processor operations that are executed without any intervening synchronization operations, such as processor operations that are executed at a time after one or more first device(s) have stopped (e.g., temporarily stopped, etc.) executing one or more synchronization operations with the one or more second devices. In some instances, processor operations that are asynchronous with respect to one or more second devices (e.g., with respect to a neighboring partition) can include processor operations that do not depend on (e.g., are independent of, etc.) synchronization with the second device(s), such as processor operations having an outcome that is unchanged by synchronization or lack of synchronization with the second device(s); processor operations that are unaffected by a timing of second-device processor operations; processor operations that do not depend on second-device timing data; or the like.

In some instances, a computing system 100 can include a distributed computing system. A distributed computing system can include, for example, a computing system in which multiple computing devices or multiple processor devices can work together (e.g., in parallel, in series, etc.) to perform a complex computation. For example, in some instances, a distributed computing system can include a plurality of partitions 102, 104, 106, 110, 114, 116 working together (e.g., in series, etc.) to perform a computational task (e.g., machine-learning inference task, etc.), with each partition comprising multiple computing devices or multiple processor devices working together (e.g., in parallel, etc.) to perform a subtask of the computational task (e.g., subtask comprising one or more layers of a machine-learning model, etc.).

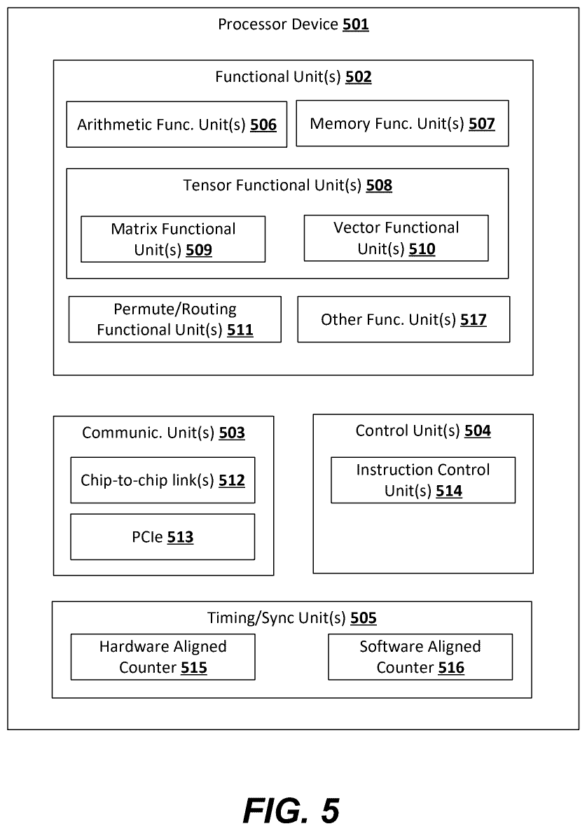

An input partition 102 can include, for example, a portion of the computing system 100 comprising one or more computing devices. For example, in some instances, an input partition 102 can include a plurality of computing devices, each computing device having one or more processor devices. In some instances, an input partition 102 can include a synchronized partition comprising a plurality of computing devices configured to perform one or more synchronization operations to synchronize one or more first computing devices of the plurality of computing devices with one or more second computing devices of the plurality of computing devices. In some instances, one or more computing devices or processor devices of the input partition 102 can include one or more deterministic computing devices or deterministic processor devices, such as deterministic devices configured to deterministically execute instructions in a program order determined at compile time by a compiler; deterministic devices configured to deterministically execute instructions at a predetermined time (e.g., predetermined absolute clock cycle; predetermined relative clock cycle such as a predetermined number of clock cycles between an executed instruction and a reference point, wherein a reference point can include a prior executed instruction, a starting time of a compiled program, or another reference; etc.) determined at a compile time by a compiler; deterministic devices that may lack one or more sources of non-determinism such as branch prediction units; or the like. In some instances, one or more processor devices of an input partition 102 can have one or more properties described herein with respect to FIG. 5 and a processor 501. In some instances, an input partition 102 can include an input-layer synchronized partition that includes or corresponds to an input layer of the computing system 100, or an input-layer synchronized partition that implements an input layer of a computational operation (e.g., machine-learning operation, etc.).

In some instances, an input partition 102 can include or be associated with a plurality of communication channels (sometimes referred to herein as communication links), such as a plurality of within-partition communication channels; one or more between-partition communication channels; and one or more external communication channels to communicate with an external destination that is external to the partition(s) 102, 104, 106, 110, 114, 116 or processors thereof (e.g., external memory device; external computing device associated with a user query; controller or scheduler computing device of the computing system 100; etc.); or the like. For example, in some instances, an input partition 102 can have a plurality of within-partition chip-to-chip communication channels, each of which may link a respective first processor device of the input partition 102 with a respective second processor device of the input partition 102. As another example, in some instances, an input partition 102 can have a plurality of between-partition chip-to-chip communication channels, such as a plurality of between-partition chip-to-chip communication channels each linking a respective first processor device of the input partition 102 with a respective second processor device of the second partition 104.

In some instances, an input partition 102 can include or be associated with one or more external communication links, such as one or more PCIe connections configured to receive input data indicative of one or more computing operations to be performed. For example, in some instances, an input partition 102 can include an external link to a controller or scheduler device of the computing system 100, and the controller or scheduler device can provide, via the external link, one or more of: a program identifier indicative of a compiled program to be executed by one or more partitions 102, 104, 106, 110, 114, 116; input data indicative of one or more inputs to the compiled program (e.g., natural language input(s); token input(s); logit activation input(s) or machine-learned embedding input(s); image, video, audio, or multimodal inputs; etc.); parameter data indicative of one or more parameters of the compiled program (e.g., input parameters, configuration parameters, user identifier for loading user state data, etc.); or other data.

In some instances, an input partition 102 or component thereof can be configured to send or receive data over one or more communication channels according to a deterministic communication protocol. For example, in some instances, each computing device or processor device of the input partition 102 can be configured to send or receive data to or from other device(s) of the input partition 102 according to a deterministic communication protocol. As another example, in some instances, one or more computing devices or processor devices of the input partition 102 can be configured to send data to one or more devices (e.g., computing devices, processor devices, memory devices, etc.) of the second partition 104 according to a deterministic communication protocol. Further details of an example deterministic communication protocol are provided below with respect to FIG. 2 and data transmissions 226.

In some instances, device(s) of the input partition 102 can send, to one or more devices of the second partition 104, data comprising one or more of: program invocation data (e.g., program identifier data indicative of a program to be executed by the second partition 104, configuration parameter data, etc.), input data to be provided as input to one or more operations (e.g., processor operations, etc.) of the second partition 104; or other data. As a non-limiting illustrative example, in some instances, an operation performed by a plurality of partitions 102, 104, 106, 110, 114, 116 can include a machine-learning operation (e.g., forward pass operation, inference operation, etc.). For example, in some instances, a machine-learning operation can include an operation associated with a machine-learning model comprising a plurality of layers, such as a sequence of layers to be implemented in serial. In some instances, each of a plurality of partitions 102, 104, 106, 110, 114, 116 can be assigned to implement one or more layers of the machine-learning model. For example, an input partition 102 can be assigned to implement N layers (e.g., the sequentially first N layers in a sequence of layers of the machine-learning model; an input layer of the machine-learning model followed by (N−1) hidden layers; etc.), where N is a positive integer; a second partition 104 can be assigned to implement another N layers (e.g., the sequentially next N layers immediately following layers implemented by the input partition 102 in a sequence of layers of the machine-learning model; etc.), or a number of layers other than N; and so on. Continuing the example, in some instances, the input partition 102 can send, to the second partition 104, various kinds of data to cause the second partition 104 to implement one or more layers of the machine-learning model. For example, in some instances, the input partition 102 can send, to the second partition 104, one or more activation values (e.g., logic activations, embedding values, intermediate activations, etc.) to be provided as input to a sequentially first layer of a plurality of model layers to be implemented by the second partition (e.g., a sequentially (N+1)th layer of the machine-learning model, etc.). As another example, in some instances, the input partition 102 can send, to the second partition 104, data indicative of the machine-learning model or layers to be implemented, such as a model identifier indicative of the model; a program identifier (e.g., program index associated with a program lookup table, program address such as memory address, program name such as filename, etc.) indicative of a compiled program for implementing the machine-learning model; memory address data (e.g., gather map data, etc.) indicative of one or more memory addresses storing instruction(s) for implementing the machine-learning model; or other data indicative of the machine-learning model. In some instances, the input partition 102 can send other data, such as parameter data, constraint data, or other data.

In some instances, an input partition 102 can include a plurality of devices (e.g., computing devices, processor devices, etc.) configured to perform operations (e.g., processor operations, etc.) in parallel. For example, in some instances, an input partition 102 can include a plurality of compute nodes, each compute node having one or more processor devices. In some instances, a plurality of parallel operations performed by an input partition 102 can include a plurality of independent operations (e.g., separate or standalone operations, etc.) or a plurality of interdependent operations, such as a plurality of interdependent subtasks of an overall computational task performed by the input partition 102. As a non-limiting illustrative example, a computing operation performed by an input partition 102 can include one or more layers of a machine-learning model. Continuing the illustrative example, in some instances, a plurality of processor devices can each independently (e.g., without necessarily relying on result data output by one or more other processor devices of the input partition 102, etc.) implement one or more nodes (e.g., node(s) each comprising a tensor multiplication operation and an activation function operation, etc.) of a first layer of the one or more layers based on one or more inputs received from an external communication channel (e.g., from a controller or scheduler computing device, etc.). Continuing the illustrative example, in some instances, each processor device of a plurality of processor devices can implement one or more nodes of a second layer of the one or more layers based on result(s) of the first-layer operations, such as based at least in part on result data received from a plurality of other processor devices of the input partition 102.

In some instances, a plurality of devices (e.g., computing devices, processor devices, etc.) of the input partition 102 can distribute data (e.g., result data determined by processor devices of the input partition 102, input data received from an external source, program invocation data such as a program index indicative of a stored program, stored data such as machine-learning model parameter data or compiled program data, etc.) amongst the plurality of devices of the input partition 102 via one or more communication operations, such as collective communication operations (e.g., broadcast, all-gather, all-to-all, etc.), pairwise communication operations, or other communication strategy. For example, in some instances, one or more data items (e.g., program index, input data, etc.) can be distributed to a plurality of processor devices according to a spanning tree distribution strategy. For example, in some instances, a root node of the input partition 102 or another partition 104, 106, 110, 114 can be configured to receive, via one or more communication channels (e.g., external communication channels, chip-to-chip or partition-to-partition communication channels, asynchronous communication channels, synchronous communication channels, etc.), one or more data items (e.g., program index, input data, etc.); and broadcast, directly or indirectly, the data item(s) to one or more (e.g., some or all, etc.) processor devices of the input partition 102. Indirect broadcasting can include, for example, providing the data item(s) to one or more child processor devices of the root node in a spanning tree of the input partition, wherein the child processor device(s) are configured to subsequently provide the data item(s) to one or more children of the child processor device(s) in the spanning tree, and so on until the data item(s) have been provided to each of a plurality of target device(s) (e.g., most or all devices of a spanning tree of the input partition 102, etc.).

In some instances, an input partition 102 can include a synchronized input partition configured to maintain synchronization between a plurality of synchronized processor devices. In some instances, synchronizing a plurality of processor devices of the input partition 102 can include performing a plurality of pairwise synchronizations, such as a plurality of pairwise synchronization operations according to a spanning tree of the input partition 102. In some instances, pairwise synchronization of two computing devices or processor devices can include passing one or more timing messages between the devices or partitions; and synchronizing based on the timing message(s). For example, a first device can send one or more messages indicating a current time according to the first device's system clock; and the second device can synchronize its own operations with the first device's operations based on the message(s) and based on knowledge of a latency of a communication link between the first and second devices. As a non-limiting illustrative example, in some instances, a first device can provide, to a second device, a plurality of timing messages at a high frequency (e.g., one message per clock cycle, one message per two clock cycles, etc.). In some instances, a timing message can include a message indicative of a current time according to a system clock of the first device. In some instances, a timing message can include a message indicative of a current clock cycle as indicated by a clock cycle counter (e.g., hardware counter, etc.) of the sending device, such as a message comprising an integer indicative of a current clock cycle count. In some instances, a second device can receive the plurality of timing messages, and can update a hardware counter of the second device based on the plurality of timing messages. For example, in some instances, a second device can maintain a first clock cycle counter configured to track a clock cycle counter of the first device, and the second device can update the clock cycle counter based on one or more of the timing messages (e.g., to cause the second device's counter to be synchronized with the first device's counter, etc.). In some instances, timing messages can be sent at a high frequency over a communication channel (e.g., deterministic communication channel, etc.) having known latency properties (e.g., known fixed latency, known average latency, known jitter, etc.), such that a second device can synchronize a synchronized hardware counter of the second device with a clock cycle counter of the first device with high precision, subject to a jitter of a communication channel between the first and second devices.

In some instances, synchronizing a second device with a first device based on timing messages can include implementing, at one or more times (e.g., occasionally, periodically, at a lower frequency compared to a frequency of the timing message(s), responsive to one or more timing triggers in a compiled program implemented by the device(s), etc.) a synchronization delay based on the timing message(s) (e.g., based on a clock cycle counter indicative of the timing message(s), etc.). For example, in some instances, the first device can implement a fixed-length delay at one or more first times (e.g., at each of a plurality of timing triggers in a program being executed by the first device, etc.). Continuing the example, in some instances, the second device can implement (e.g., at the one or more first times; at one or more second times having a known, predetermined temporal relationship with the one or more first times; etc.) a variable-length delay based on the timing messages, such as based on a comparison between a synchronized counter (e.g., a “hardware-aligned counter” as discussed below with respect to FIG. 5, etc.) updated based on the timing messages and a local counter tracking a current software clock cycle of a program being executed by the second device (e.g., a “software-aligned counter” as discussed below with respect to FIG. 5, etc.). For example, in some instances, if a comparison between a local counter and a synchronized counter indicates that the second device is running N clock cycles ahead of the first device, where N can be an integer, then the second device can implement a delay of (F+N) clock cycles, where F is a number of clock cycles of a fixed delay implemented by the first device. Similarly, in some instances, if a comparison between a local counter and a synchronized counter indicates that the second device is running N clock cycles behind the first device, then the second device can implement a delay of (F−N) clock cycles.

In some instances, a plurality of devices of an input partition 102 can be synchronized in various ways, such as according to a one-to-all broadcast strategy (e.g., one first device broadcasting timing messages to a plurality of second devices, etc.), a spanning tree strategy (e.g., a root node sending timing messages to one or more child nodes; the child node(s) synchronizing themselves to the root node based on the timing messages and sending additional timing messages to one or more grandchild node(s), and so on; etc.), or other synchronization operation.

In some instances, a second partition 104 can share or not share one or more properties with the input partition 102. For example, in some instances, a second partition 104 can have any property described herein with respect to an input partition 102, and vice versa.

In some instances, a second partition 104 can include a partition that includes or does not include one or more external connections described herein with respect to input partition 102, such as a partition that may lack an external connection to a device (e.g., controller or scheduler device of the computing system 100, etc.) for providing initial input to the input partition 102; a partition that may include or not include one or more other external connections, such as connections to external memory for caching user state data; or the like.

In some instances, a second partition 104 can have one or more properties that are the same as or different from a corresponding property of an input partition 102, such as a same or different number of computing devices or processor devices; a same or different mix of device type(s); a same or different within-partition interconnection topology; a same or different between-partition connection topology; or other property. For example, in some instances, a computing system 100 can include a plurality of identical partitions arranged in a ring-like between-partition topology (e.g., input partition 102 connected to both second partition 104 and another partition such as output partition 116, etc.) to facilitate interchangeability of partitions and efficient reallocation of workloads to partitions (e.g., such that one or more partitions can be taken offline for maintenance, etc.). As another example, in some instances, a computing system 100 can include a plurality of specialized partitions configured for different workload types (e.g., machine-learning layer types such as convolutional layer, attention head, selective structured state space machine layer, etc. ; machine-learning layer sizes, etc.), and the second partition 104 can have one or more properties (e.g., processor type(s), partition size, etc.) different from another partition 102, 106, 110, 114, 116. Other examples are possible.

In some instances, a second partition 104 can include or be associated with a first set of between-partition communication links to an input partition 102; and a second set of between-partition communication links to one or more other partitions, such as a partition that is sequentially third along the data flow axis 130.

In some instances, a second partition 104 can be configured to temporarily synchronize with, and receive data from, an input partition 102, such as in any manner described below with respect to a (K+1)th partition 110 synchronizing with, and receiving data from, a Kth partition 106. Similarly, in some instances, a second partition 104 can be configured to temporarily synchronize with, and transmit data to, one or more other partitions (e.g., a partition that is sequentially third along the data flow axis 130, etc.) of the computing system 100.

In some instances, a second partition 104 or other partition 106, 110, 114 can include an intermediate-layer synchronized partition that includes or corresponds to an intermediate layer of the computing system 100, or an intermediate-layer synchronized partition that implements an intermediate layer of a computational operation (e.g., machine-learning operation, etc.).

In some instances, a Kth partition 106, (K+1)th partition 110, or (K+2)th partition 114 can share or not share one or more properties with an input partition 102 or second partition 104. For example, in some instances, a Kth partition 106, (K+1)th partition 110, or (K+2)th partition 114 can have any property described herein with respect to an input partition 102 or second partition 104, and vice versa. In some instances, a Kth partition 106, (K+1)th partition 110, or (K+2)th partition 114 can have one or more properties that are the same as or different from a corresponding property of another partition 102, 104, 106, 110, 114, 116, such as a same or different number of computing devices or processor devices; a same or different mix of device type(s); a same or different within-partition interconnection topology; a same or different between-partition connection topology; or other property.

In some instances, a Kth partition 106 can include a partition that is connected via one or more communication channels to the (K+1)th partition 110 and one or more other partitions. For example, in some instances, a Kth partition 106 can include a partition configured to temporarily synchronize with (e.g., expand a synchronous domain of the Kth partition 106 to include, etc.) the (K+1)th partition 110 to send Kth result data 112. As another example, in some instances, a Kth partition 106 can include a partition configured to temporarily synchronize with one or more other partitions and synchronously send or receive data (e.g., result data, program invocation data, machine-learning model parameter data, stored data retrieved from memory, or other data) to or from the other partition(s).

Similarly, a (K+1)th partition 110 can include a partition that is connected via one or more communication channels to the Kth partition 106, (K+2)th partition 114, or one or more other partitions. For example, in some instances, a (K+1)th partition 110 can include a partition configured to temporarily synchronize with (e.g., expand a synchronous domain 108 of the (K+1)th partition 110 to include, etc.) the (K+2)th partition 114 to send (K+1)th result data 118. As another example, in some instances, a (K+1)th partition 110 can include a partition configured to temporarily synchronize with (e.g., expand a synchronous domain of the (K+1)th partition 110 to include, etc.) the Kth partition 106 to receive Kth result data 112. As another example, in some instances, a (K+1)th partition 110 can include a partition configured to temporarily synchronize with one or more other partitions and synchronously send or receive data (e.g., result data, program invocation data, machine-learning model parameter data, stored data retrieved from memory, or other data) to or from the other partition(s).

A synchronous domain 108 can include, for example, a set of components (e.g., partitions; computing devices or processor devices of a partition; etc.) that participate in one or more shared synchronization operations. In some instances, a synchronous domain 108 can include a set of devices that are currently synchronized with each other according to a synchronization protocol, such as a set of devices that participated in a most recent round (e.g., iteration, etc.) of synchronization operations associated with the synchronous domain 108. Expanding a synchronous domain 108 can include, for example, expanding a set of components that participates in a synchronization operation associated with the synchronous domain 108, such as by causing one or more new devices to participate in a next round of synchronization operations associated with the synchronous domain 108, or by merging the synchronous domain 108 with a neighboring synchronous domain associated with a neighboring set of components (e.g., neighboring partition comprising a plurality of computing devices, etc.).

Contracting a synchronous domain 108 can include, for example, contracting (e.g., shrinking, reducing, etc.) a set of components that participates in a synchronization operation associated with the synchronous domain 108, such as by causing one or more devices that participated in a most recent round of synchronization operations to avoid participating in a next round of synchronization operations associated with the synchronous domain 108. As a non-limiting illustrative example, expanding a synchronous domain 108 associated with a (K+1)th partition 110 to include a Kth partition 106 can include adding the Kth partition 106 or devices thereof to a set of components that are currently participating in synchronization operations with the (K+1)th partition 110, such as by causing one or more computing devices of the Kth partition 106 to participate in a synchronization operation of the (K+1)th partition 110. As another example, contracting a synchronous domain 108 to include only the (K+1)th partition 110 can include removing one or more components from a set of components that are currently participating in synchronization operations with the (K+1)th partition, such as by causing one or more computing devices that participated in a previous synchronization operation of the (K+1)th partition 110 to avoid participating in a next synchronization operation of the (K+1)th partition 110.

In some instances, synchronizing a (K+1)th partition 110 with a Kth partition 106 can include one or more synchronization operations described above with respect to an input partition 102 and within-partition synchronization. For example, in some instances, one or more first device(s) of a first partition 106, 110 can provide one or more timing messages to one or more second device(s) of a second partition 106, 110 (e.g., to a root node of a spanning tree of the second partition 106, 110, etc.); and devices of the second partition 106, 110 can synchronize themselves to the first device(s) based on the timing messages. In some instances, synchronizing a synchronous domain 108 comprising two partitions 106, 110 can include operations similar to (e.g., same as, etc.) or different from one or more operations for synchronizing a synchronous domain 108 comprising one partition (e.g., operations described above with respect to an input partition 102, etc.). For example, in some instances, synchronizing two partitions 106, 110 can be otherwise identical to synchronizing one partition 110, with an expanded number of processor devices (e.g., expanded spanning tree of pairwise interactions, expanded one-to-all or one-to-many broadcast operation, etc.).

Kth result data 112 can include, for example, any data sent from a Kth partition 106 to a (K+1)th partition 110. In some instances, Kth result data 112 can include data (e.g., output data, etc.) indicative of a result of one or more operations executed by the Kth partition 106. Kth result data 112 can include data of various data types, and can have one data type or multiple data types. Some example data types for Kth result data 112 can include numerical data types, such as full-precision (e.g., 32-bit, 64-bit, etc.) or quantized (e.g., 16-bit, bfloat 16-bit, 8-bit, 4-bit, 2-bit, 1-bit, ternary, etc.) numerical data types (e.g., floating-point data types, integer data types, etc.). In some instances, Kth result data 112 can include one or more output activations (e.g., logit activations, etc.) of one or more machine-learning model layers implemented by the Kth partition 106.

In some instances, a (K+2)th partition 114 can include a partition that is connected via one or more communication channels to the (K+1)th partition 110 and one or more other partitions. For example, in some instances, a (K+2)th partition 114 can include a partition configured to temporarily synchronize with (e.g., expand a synchronous domain of the (K+2)th partition 114 to include, etc.) the (K+1)th partition 110 to receive (K+1)th result data 118. As another example, in some instances, a (K+2)th partition 114 can include a partition configured to temporarily synchronize with one or more other partitions and synchronously send or receive data (e.g., result data, program invocation data, machine-learning model parameter data, stored data retrieved from memory, or other data) to or from the other partition(s).

In some instances, an output partition 116 can include a partition that is connected to one or more partitions and configured to temporarily synchronize with the one or more partitions to synchronously receive data (e.g., result data, etc.). In some instances, an output partition 116 can include one or more external communication links to output data (e.g., result data, inference outputs, etc.) to one or more external devices, such as a controller, scheduler, or requester device that may be the same device or a different device from which an input partition 102 may receive input data.

In some instances, an output partition 116 can include an output-layer synchronized partition that includes or corresponds to an output layer of the computing system 100, or an output-layer synchronized partition that implements an output layer of a computational operation (e.g., machine-learning operation, etc.).

In some instances, (K+1)th result data 118 can have any property described herein with respect to Kth result data 112, and can have one or more properties (e.g., data types such as quantization strategies; data amounts such as model dimension, layer output dimension, number of activations output by a layer, number of data items output by the (K+1)th partition 110, etc.) that are the same as or different from a corresponding property of the Kth result data 112.

A data flow axis 130 can include, for example, an axis indicative of one or more directions of data flow within a computing system 100. A direction of data flow can include or correspond to, for example, a directed edge of a graph of the computing system 100, comprising a plurality of nodes, each node associated with one or more partitions 102, 104, 106, 110, 114, 116 or other devices. For example, in some instances, a direction of data flow can include a directed edge from a sending partition that sends result data 112, 118 to a receiving partition 110, 114 that receives the result data provided by the sending partition (e.g., receives the result data directly from the sending partition, etc.).

Although FIGS. 1A-1C depict a data flow axis 130 as a linear axis for convenience and ease of understanding, a data flow axis 130, computing system 100, or computing operation performed by the computing system 100 can have any geometry without deviating from the scope of the present disclosure. For example, in some instances, a computing system 100 or subset thereof (e.g., subset of processors allocated to a given computing operation, etc.) can include various kinds of non-linear geometries (e.g., three-dimensional grid-like geometries, etc.), such as a computing system 100 having a plurality of racks arranged in a plurality of rows (e.g., arranged in a grid, etc.), with each rack having a plurality of computing devices arranged vertically within the rack. As another example, in some instances, a data flow axis 130 can include a data path (e.g., directed edge, etc.) between any group of two or more nodes, such as between nodes that are geographically close together (e.g., neighboring nodes within the same rack, etc.) or geographically far apart (e.g., nodes at opposite ends of one or more row(s) of racks, etc.) within the computing system 100.

In some instances, a data flow axis 130 or data flow of a computing system 100 or computing operation can include a branched data flow without deviating from the scope of the present disclosure. For example, in some instances, a partition 102, 104, 106, 110, 114, 116 can be configured to receive result data from a plurality of neighboring partitions; provide result data to a plurality of neighboring partitions; or both.

In some instances, a data flow axis 130 or data flow of a computing system 100 or computing operation can include a recursive or cyclic data flow without deviating from the scope of the present disclosure. For example, in some instances, a partition 102, 104, 106, 110, 114, 116 can be configured to receive result data from a first neighboring partition; and subsequently provide, to the first neighboring partition, additional result data generated by the partition 102, 104, 106, 110, 114, 116. As another example, in some instances, a data flow can include a cyclic data flow, such as a data flow comprising a first partition providing first data to a second partition; the second partition providing second data to a third partition; and the third partition providing third data to the first partition.

In some instances, a path length of the computing system 100 or computational operation along a data flow axis 130 (e.g., a path length of a data flow path of a data flow graph of the computing system 100 or computational operation, etc.) can include a path length greater than five partitions; such as greater than ten partitions; such as greater than 20 partitions; such as greater than 50 partitions; etc. For example, in some instances, a computing operation can include an inference operation associated with a machine-learning model having a plurality of layers, such as a deep learning model having more than 20 layers; such as more than 40; such as more than 80; such as more than 100; etc. Continuing the example, in some instances, each of a plurality of partitions of the computing system can implement a small number of such layers, such that a number of partitions used to implement the machine-learning model is greater than five or the like. For example, in some instances, each of a plurality of partitions of the computing system can implement a number of layers less than 20, such as less than 10, such as less than five, such as less than or equal to two, such as one. As used herein, a “path length” of a computing system 100, computational operation, or subset thereof can refer to a longest acyclic directed sequence of partitions of a graph of the computing system 100 or operation (e.g., a directed graph of propagated synchronization operations for passing result data between partitions, etc.). As a non-limiting illustrative example, a data flow consisting of first data sent from a first partition to a second partition; and second data sent from the second partition to a third partition has a path length of three.

FIG. 2 depicts a sequence flow diagram of an example assembly-line-style propagated synchronization operation according to example implementations of aspects of the present disclosure. A computing system 200 can include a plurality of partitions 202, 210a, b, c, d, 216, each represented in FIG. 2 by a dashed horizontal line. Each partition 202, 210a, b, c, d, 216 can perform one or more operations at one or more times, depicted in FIG. 2 as pictorial elements along a time axis 228.

A first partition 202 can receive input data via a first non-deterministic I/O operation 220a. The first partition 202 can perform one or more first processor operations 222a of a first computation to generate first result data. Shortly prior to completing the first processor operation(s) 222a, the first partition 202 can provide a notification 224 to a second partition 210a, the notification indicating that the first partition 202 will soon begin transmitting the first result data. Upon completing or shortly prior to completing the processor operations, the first partition 202 can initiate a data transmission 226 transmitting the first result data to the second partition 210a. Subsequently, the second partition 210a can begin performing second processor operations 222b of the first computation based on the first result data, while the first partition 202 can move on to a second computation. For example, the first partition 202 can subsequently receive second input data via a second non-deterministic I/O operation 220b; perform first processor operations 222c of a second computation; and provide a notification 224 and data transmission 226 associated with the second computation to the second partition 210a. In some instances, operation(s) performed by the first partition 202 for the second computation or later computation(s) can overlap in time with operations performed by other partitions 210a, 210b, 210c, 210d, 216 for the first computation. For example, the first partition 202 can perform second-computation operations 220b, 222c at a time that the second partition 210a is performing first-computation operations 222b, 224, 226; can perform third-computation operations 220c, 222d at a time that the third partition 210b or another partition (e.g., fourth partition 210c, etc.) is performing first-computation operations 222, 224, 226; and so on.

Additionally, while the first partition 202 is performing first operations 222c, d of second, third, and later computations, the first computation can proceed through a plurality of partitions 210a, b, c, d, 216 according to a propagated synchronization operation. For example, a second partition 210a can perform second operations 222b associated with the first computation, and can transmit a result of the second operations 222b to the third partition 210b. The third partition 210b can perform third operations 222e associated with the first computation, and can transmit a result of the third operations 222e to the fourth partition 210c. The fourth partition 210c can perform fourth operations 222f associated with the first computation, and can transmit a result of the fourth operations 222f to the fifth partition 210d. The fifth partition 210d can perform fifth operations 222g associated with the first computation, and can transmit a result of the fifth operations 222g to an output partition 216. The output partition 216 can perform sixth operations 222h associated with the first computation, and can output a result of the first computation via a non-deterministic I/O operation.

In some instances, a computing system 200 can be configured to perform operations in an “assembly line” configuration (e.g., as shown in FIG. 2, etc.). For example, in some instances, a first partition 202 can be configured to perform operations 220a, 222a associated with a first multi-partition computing operation; pass a result of the operations 220a, 222a to a second partition 210a; and move on to operations 220b, 222c of a second computation, without necessarily revisiting or interacting with the first computation after passing the result to the second partition. In some instances, each set of operations 222b, 222c, 222d, 222e, 222f, 222g, 222h can include independent operations performed independently of neighboring partitions, such as operations performed asynchronously with respect to the neighboring partitions (e.g., without transmitting or receiving synchronization signals; without synchronizing, delaying, or otherwise altering a timing of the operations 222 based on synchronization signal(s) that are sent and received; etc.); operations performed without communicating with or otherwise interacting with the neighboring partitions; operations that are not based on data received from the neighboring partitions; or the like.

In some instances, a partition 202, 210, 216 can be, comprise, be comprised by, or otherwise share one or more properties with a partition 102, 110, 116. For example, in some instances, a partition 202, 210, 216 can have any property described herein with respect to a partition 102, 110, 116, and vice versa.

A non-deterministic input/output (I/O) operation 220a, b, c, d can include, for example, an I/O operation to send or receive data over a non-deterministic communication channel, or to send or receive data to or from a non-deterministic device. In some instances, a communication channel associated with a non-deterministic I/O operation 220 can include a peripheral component interconnect express (PCIe) channel, an ethernet channel, or other communication channel. In some instances, a communication channel associated with a non-deterministic I/O operation 220 can include an asynchronous communication channel. In some instances, a non-deterministic I/O operation 220 can include a communication operation according to an asynchronous communication protocol. In some instances, a non-deterministic I/O operation 220 can include an I/O operation involving one or more components having non-deterministic behavior, such as non-deterministic behavior leading to non-deterministic latency of the non-deterministic I/O operation 220. For example, in some instances, a non-deterministic I/O operation 220 can include an I/O operation over a non-deterministic communication channel having non-deterministic communication latency, such as a communication channel comprising one or more non-deterministic routing components or a communication channel implementing a non-deterministic routing protocol (e.g., dynamic load balancing protocol, etc.). As another example, in some instances, a non-deterministic I/O operation 220 can include an I/O operation interacting with a non-deterministic source device or destination device, such as an I/O operation receiving data from a source device configured to transmit data at non-deterministic times; an I/O operation sending data to a non-deterministic device; or the like.

In some instances, a non-deterministic I/O operation 220 can be performed by a deterministic computing device of a partition 202, 210, 216, such as a deterministic computing device configured to perform one or more other operations (e.g., processor operations 222, etc.) at a predetermined time determined at a compile time by a compiler. In some instances, a compiled program to cause a deterministic device to perform non-deterministic I/O operation(s) 220 and deterministic operation(s) 222 can include a compiled program that allocates a time window (e.g., time buffer, etc.) to the non-deterministic I/O operation(s) 220, wherein the non-deterministic I/O operation(s) 220 can occur at any time within the time window, and wherein the deterministic operation(s) 222 are configured to occur at a predetermined time after the time window. For example, in some instances, a size of the time window (e.g., number of clock cycles, number of microseconds, etc.) can be based at least in part on a timing variance associated with a non-deterministic communication channel or communication device, or a timing variance of a plurality of non-deterministic I/O operations 220.

Although FIG. 2 depicts only an input partition 202 and an output partition 216 performing non-deterministic I/O operations 220, one or more other partitions 210a, b, c, d can perform non-deterministic I/O operations 220 without deviating from the scope of the present disclosure. For example, in some instances, one or more partitions 202, 210, 216 can be configured to perform non-deterministic I/O operations 220 (e.g., via a non-deterministic or asynchronous communication link, etc.) to send or receive data to an external memory device (e.g., dynamic random access memory (DRAM) device, etc.). For example, in some instances, one or more computing devices of a partition 202, 210, 216 can perform user state caching using one or more external memory devices, such as by providing (e.g., via one or more non-deterministic or asynchronous communication links) user state cache data to one or more external memory devices (e.g., external memory devices having non-deterministic read or write latency, etc.); subsequently retrieving (e.g., in response to a later inference request associated with a same user, etc.) the user state cache data; and using the retrieved user state cache data to perform one or more subsequent operations (e.g., machine-learning operations, etc.). In some instances, user state cache data can include data indicative of a state of one or more user interaction(s) (e.g., multi-turn conversation(s) comprising one or more user inputs and one or more user outputs, etc.), cached computational state data (e.g., key-value cache data, etc.) indicative of a computational state associated with one or more prior operations (e.g., prior inference operations, etc.), or other user state data.

In some instances, a non-deterministic I/O operation 220 can include an I/O operation performed using one or more I/O buffers. For example, in some instances, a partition 202 or processor device can write output data to an output buffer; and post a semaphore indicating that data of the output buffer is ready for transmission. Continuing the example, in some instances, a data transmission device (e.g., PCIe transmitter unit, input/output chiplet, etc.) can wait for a semaphore; and, responsive to a semaphore being posted, transmit data from the output buffer over a non-deterministic I/O connection.

Processor operations 222 can include, for example, any operations performed by one or more processor devices, such as floating-point operations (e.g., multiplication, addition, activation function operations, data type conversion such as quantization, etc.), tensor operations (e.g., matrix multiplication operations, etc.), vector operations (e.g., activation function operations, etc.), or other operations. In some instances, processor operations 222 can include one or more machine-learning operations (e.g., machine-learning inference operations, etc.), such as one or more operations (e.g., tensor operations, vector operations, etc.) associated with a layer of a machine-learning model.

In some instances, processor operations 222 can include one or more parametrized operations, such as tensor operations based on one or more input tensor(s) and one or more parameter tensors (e.g., tensor comprising a plurality of weight parameters of a machine-learning model, etc.). In some instances, a partition 202, 210, 216 can store (e.g., in memory, etc.) one or more parameters of the parametrized operations, and can perform the processor operations 222 based on the stored parameters. In some instances, a partition 202, 210, 216 can reuse one or more stored parameters (e.g., some or all of a plurality of stored parameters, etc.) for a plurality of processor operations 222. As a non-limiting illustrative example, an input partition 202 can receive first input data via a first non-deterministic I/O operation 220a; perform first processor operations 222a executing one or more first layers of a machine-learning model on the first input data; subsequently receive second input data via a second non-deterministic I/O operation 220b; and perform second processor operations 222c executing the first layer(s) of the machine-learning model on the second input data.

In some instances, a plurality of sets of processor operations 222a, c, d performed by a given partition 202 can include similar (e.g., same, etc.) operations or different operations. For example, in some instances, a partition 202, 210, 216 can execute a similar (e.g., same, etc.) compiled program on each of a plurality of inputs, such as a similar (e.g., same, etc.) parametrized machine-learning inference operation. As another example, in some instances, a partition 202, 210, 216 can execute different compiled programs for each of a plurality of different inputs. For example, in some instances, an input partition 202 can receive program data indicative of a compiled program (e.g., program identifier data such as a numerical program index, program name, memory address associated with a program, etc.), and can perform one or more processor operations 222 associated with the compiled program based on the program data. In some instances, performing processor operations 222 based on the program data can include retrieving (e.g., from memory, etc.) one or more computer-executable instructions based on the program data and executing the instruction(s). In some instances, program data (e.g., program identifier data, etc.) can be provided to subsequent partitions 210, 216 via one or more notification 224 or data transmission 226 operations, and the subsequent partitions 210, 216 can perform processor operations 222 based on the program data. In some instances, a computing system 200 can execute a plurality of iterations of assembly-line-style propagated synchronization operations. In some instances, different iterations (e.g., consecutive iterations, etc.) of the plurality of iterations can include iterations executing the same processor operations 222 on different data (e.g., different input data received by an input partition 202, etc.), or different processor operations (e.g., processor operations associated with a different compiled program or different machine-learned model, etc.).

In some instances, processor operations 222 can include synchronized processor operations that are synchronous with respect to a partition 202, 210, 216 performing the processor operations 222. In some instances, a set of processor operations 222 can include a plurality of operations executed in parallel (e.g., by a plurality of synchronized devices of a partition 202, 210, 216, etc.). In some instances, synchronized processor operations can include one or more operations performed based on a synchronized timing between two or more devices of the partition 202, 210, 216, such as deterministic operations (e.g., deterministic chip-to-chip communication operations, etc.) performed at one or more predetermined times predetermined at compile time by a compiler. In some instances, a plurality of sets of processor operations 222a, b, e, f, g, h performed by a plurality of distinct partitions 202, 210, 216 can include a plurality of sequential operations performed in serial, such as a plurality of sequential operations associated with a sequence of layers of a machine-learning model.

In some instances, a serial sequence of processor operations 222a, b, e, f, g, h can include a sequence of processor operations 222a, b, e, f, g, h having a monotonically non-increasing sequence of latency values (e.g., to prevent timing conflicts, such as timing conflicts associated with a processor operation 222c, 222d of an input partition 202 completing before a processor operation 222b completes or before a next partition 210a is ready to receive data, etc.). For example, a first set of processor operations 222a can have a latency (e.g., total runtime, total latency between an end of a non-deterministic I/O operation 220a and a beginning of a corresponding data transmission 226, etc., etc.) that is greater than or equal to a corresponding latency of a second set of processor operations 222b, which can in turn be greater than or equal to a corresponding latency of a third set of processor operations 222c, and so on. In some instances, if a latency value (e.g., best-case latency, worst-case latency, average-case latency, deterministic known latency value, etc.) of an earlier set of processor operations 222 would otherwise be smaller than a corresponding latency value of a later set of processor operations 222, a delay instruction can be added to the earlier set of processor operations 222 to cause the latency values to be equal.

A notification 224 can include, for example, a communication operation to provide notification data to another partition 210, 216. For example, in some instances, notification data can include a notification indicative of an upcoming data transmission 226, such as notification data indicative of a predetermined time at which the data transmission 226 will begin. As another example, in some instances, notification data can include program data indicative of one or more processor operations to be executed based on an upcoming data transmission 226, such as program index data identifying a program to be executed on result data included in an upcoming data transmission 226. In some instances, a notification 224 can include a notification provided over a deterministic communication link (e.g., chip-to-chip communication link, etc.), such as a deterministic communication link having deterministic latency properties. In some instances, a notification 224 can include a notification provided by a deterministic computing device, such as a notification provided at a predetermined time determined at compile time by a compiler. In some instances, a notification 224 can be a lightweight (e.g., small data size, etc.) communication, such as a communication between a single device of a sending partition 202, 210 and a single device (e.g., root node of a spanning tree, etc.) of a receiving partition 210, 216. For example, in some instances, a root node of a receiving partition 202 can receive a notification 224, and can propagate the notification to one or more other computing devices of the receiving partition 210, 216, or otherwise provide instruction(s) to other computing devices of the receiving partition 210, 216 based on the notification 224.

In some instances, one or more partitions 210, 216 or computing devices thereof can be configured to provide a “backpressure” signal (e.g., notification provided to a preceding partition 202, 210 along a data flow axis 130, etc.) to prevent a data transmission 226 from being sent when the partition 210, 216 is not ready. For example, in some instances, a partition 210, 216 can determine (e.g., responsive to receiving a notification 224 indicative of an upcoming data transmission 226; at one or more predetermined times; etc.) that the partition 210, 216 is not currently ready to receive a data transmission 226, or that the partition 210, 216 will not be ready to receive a data transmission 226 at a time that a sending partition 202, 210 is scheduled to send the data transmission 226. For example, in some instances, determining that a partition 210, 216 is not ready to receive a data transmission 226 can include determining that the partition 210, 216 is waiting on one or more non-deterministic I/O operations that have not yet completed or that are not expected to complete before a time a data transmission 226 is scheduled. In some instances, a sending partition 202, 210 can, responsive to receiving a backpressure signal, pause to wait for the receiving partition 210, 216 to become ready. In some instances, a sending partition 202, 210 can also send, responsive to receiving a backpressure signal, a second backpressure signal to one or more upstream partitions (e.g., responsive to determining that the sending partition 202, 210 will not be ready to receive a data transmission 226 at a time the upstream partition is scheduled to send it, etc.). In some instances, an input partition 202 can send a backpressure signal to an external device (e.g., controller or scheduler computing device, etc.) via one or more non-deterministic I/O operations 220.

A data transmission 226 can include, for example, an operation to provide data (e.g., result data indicative of a result of one or more processor operations 222, etc.) to another partition. In some instances, a data transmission 226 can include a deterministic communication operation, such as a deterministic communication configured to occur at a predetermined time (e.g., predetermined clock cycle, etc.) determined at compile time by a compiler; a deterministic communication via a communication channel that may lack one or more non-deterministic components (e.g., dynamic load balancing components, etc.); a deterministic communication associated with one or more deterministic latency values; or the like. In some instances, a data transmission 226 operation can include a deterministic communication performed at a predetermined time indicated by a notification 224. For example, in some instances, a sending partition 202, 210 can provide a notification 224 indicative of a predetermined time at which the sending partition 202, 210 will begin sending the data transmission 226; and can begin sending the data transmission 226 at the predetermined time. As another example, in some instances, a receiving partition 210, 216 can receive a notification 224 indicative of a predetermined time at which the sending partition 202, 210 will begin sending the data transmission 226; and can process the data transmission 226 based on the predetermined time (e.g., based on a sum of the predetermined time and a predetermined deterministic latency value, etc.). In some instances, processing the data transmission 226 based on the predetermined time can include performing one or more operations (e.g., data routing operations, tensor operations, floating-point operations, memory write operations such as static random access memory (SRAM) write operations, etc.) on received data at a second predetermined time determined based on the predetermined time at which the sending partition 202, 210 began sending the data transmission 226.

In some instances, processing a data transmission 226 can include performing one or more synchronization operations (e.g., responsive to receiving a notification 224, etc.), such as executing one or more delay operations, wherein a length of the delay can be determined based on a comparison between a first counter (e.g., hardware-aligned counter, synchronized counter tracking another device, etc.) and a second counter (e.g., software-aligned counter, local counter tracking a software clock cycle of a currently executing program, etc.) of a receiving device. For example, in some instances, a receiving device or receiving partition can receive a notification 224; perform (e.g., responsive to the notification 224, etc.) a synchronization operation to synchronize with a device or partition that sent the notification 224; and process a subsequent data transmission 226 based at least in part on a predetermined timing of the data transmission 226.

In some instances, a data transmission 226 can include a distributed data transmission 226, such as a distributed data transmission wherein each respective processor device of a plurality of processor devices of a sending partition 202, 210 provides data (e.g., result data associated with processor operations 222 performed by the respective processor device, etc.) to one or more corresponding processor devices of a receiving partition 210, 216 according to one or more collective communication operations (e.g., all-gather, etc.) or pairwise communication operations.

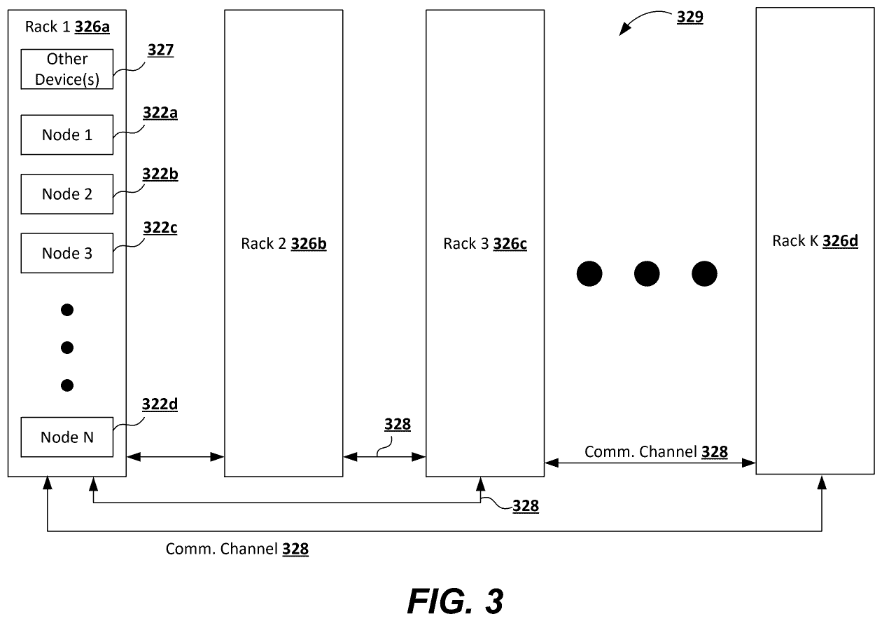

FIG. 3 is a block diagram of an example multi-rack computing system 329 according to example implementations of aspects of the present disclosure. A computing system can include, for example, a plurality of racks 326a, b, c, d, with each rack holding a plurality of computing nodes 322 (e.g., computing nodes 322, b, c, d, etc.) and one or more other devices 327, such as top-of-rack device(s) 327 or the like. The computing system can further include a plurality of communication channels 328, each communication channel 328 connecting one or more nodes of a first rack 326 to one or more nodes of a second rack 326.

In some instances, a computing node 322 can comprise one or more processor devices, such as a plurality of processor devices (e.g., eight processor devices, etc.) each having one or more properties described below with respect to FIG. 5 and processor devices 501.

A rack 326 can include, for example, a structure (e.g., server rack, cabinet, etc.) configured to contain a plurality of compute nodes 322. In some instances, a rack 326 can include a standard-sized rack for holding server computing devices, and each of a plurality of compute nodes 322 can include a standard-size compute node for being inserted into a server rack, such as a one-rack-unit (1U), 2U, or 4U node, or other standard compute node size.

Other device(s) 327 can include, for example, one or more shared devices configured to provide one or more functions to a plurality of compute nodes 322. In some instances, other device(s) 327 can include one or more communication devices, such as top-of-rack communication devices. Top-of-rack communication devices can include, for example, a top-of-rack switch; patch panel; routing panel; retimer; or other communication device.

Communication channels 328 can include various kinds of communication channels, such as electrical communication channels (e.g., conductive wiring such as copper, etc.), optical communication channels (e.g., fiber optic strands, cables, etc.), or other communication channel type. In some instances, communication channels 328 can include communication channels 328 between top-of-rack communication devices 327 (e.g., Ethernet communication channels, etc.); direct chip-to-chip communication channels 328 between a first processor device of a first rack 326 and a second processor device of a second rack; direct node-to-node communication between a first node 322 of a first rack 326 and a second node 322 of a second rack 326; or other communication channel. In some instances, a plurality of communication channels 328 can form various kinds of communication topologies, such as high-radix topologies wherein each of a plurality of processor devices of a plurality of racks 326 has multiple chip-to-chip communication ports (e.g., greater than or equal to eight, etc.). In some instances, a topology of the communication channels 328 can include one or more reconfigurable topologies, such as topologies wherein some or all of a plurality of chip-to-chip communication links 512 are each connected to one or more topology reconfiguration devices, such as one or more switches; patch panels; connectorized fixed-topology routing panels configured to route a plurality of inputs (e.g., plurality of inputs associated with a multi-strand fiber optic connector, etc.) to a plurality of outputs according to a predetermined topology, thereby enabling rapid switching between topologies by disconnecting from a first fixed-topology routing panel and connecting to a second fixed-topology routing panel.

In some instances, communication channels 328 can include one or more deterministic communication channels between different racks 326 (e.g., inter-rack deterministic communication links, etc.), such as deterministic chip-to-chip communication channels between a first processor device of a first node 322 of a first rack 326 and a second processor device of a second node 322 of a second rack 326. In some instances, a deterministic communication channel can include a communication channel that lacks one or more non-deterministic components such as dynamic load balancing components or other sources of non-determinism. In some instances, a deterministic communication channel can include a communication channel associated with one or more deterministic latency values, such as a deterministic range of possible latency values (e.g., subject to a jitter of one or more components of the communication channel, etc.), a deterministic worst-case latency value, or the like. In some instances, a deterministic communication channel can include a communication channel associated with a synchronous communication protocol, such as a communication channel over which one or more synchronous data transmissions are sent. In some instances, a synchronous data transmission can include a synchronous data transmission having any property described herein with respect to a data transmission 226, such as a data transmission sent at one or more predetermined times by one or more sending devices of a sending partition, and processed by a receiving partition based on the predetermined time(s). In some instances, a synchronous communication protocol can include a communication protocol that may lack packet header data, routing data, or other metadata, thereby reducing a communication overhead compared to some alternative communication protocols. For example, in some instances, a sending device and a receiving device can include deterministic devices that are synchronized with each other, and the receiving device can route received data based on foreknowledge of a predetermined sending operation (e.g., predetermined operation having a predetermined timing; predetermined ordering of data items; etc.), such as based on compiled computer-executable instructions for routing the received data, wherein the compiled instruction(s) were determined based on knowledge of the predetermined sending operation (e.g., by the same compiler that generated compiled instruction(s) to cause the sending device to send data according to the predetermined sending operation, etc.). In some instances, communication channels 328 can further include or not include one or more non-deterministic or asynchronous communication channels, such as PCIe communication channels, Ethernet communication channels, or other communication channels.

In some instances, communication channels 328 can include or be coupled to various communication components, such as communication ports, connections, interface units, or the like; routing or data permutation components (e.g., internal routing or permutation components such as switching components; external components coupled to the processor device 501 such as routers, repeaters, switches, panels, or the like); communication lines (e.g., electrically conductive signal traces, electrically conductive wires, optical fibers, cables, etc.); or other components configured to facilitate one or more communication operations.

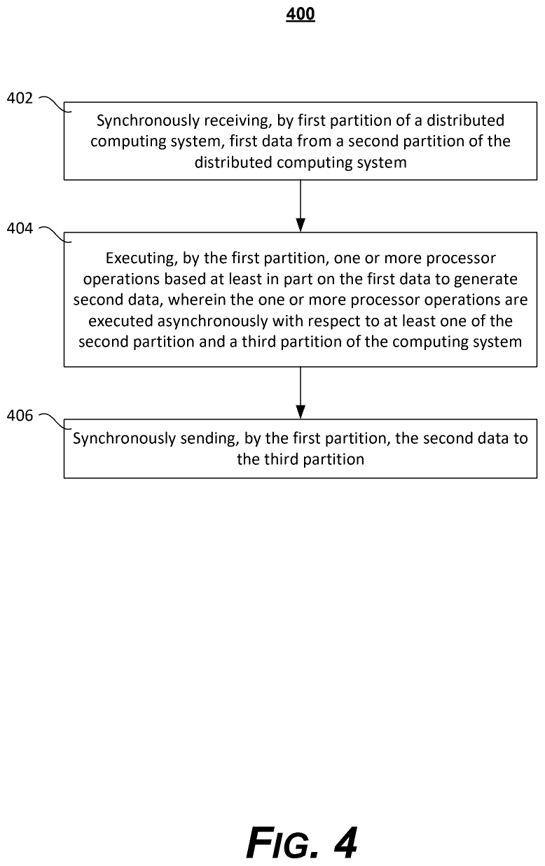

FIG. 4 depicts a flowchart diagram of an example method for propagated synchronization according to example embodiments of the present disclosure. Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

At 402, example method 400 can include synchronously receiving, by first partition (e.g., (K+1)th partition 110, etc.) of a distributed computing system (e.g., computing system 100, etc.), first data (e.g., Kth result data 112, etc.) from a second partition (e.g., Kth partition 106, etc.) of the distributed computing system. In some instances, example method 400 at 402 can include using one or more systems or performing one or more activities described with respect to FIGS. 1A-1C.

At 404, example method 400 can include executing, by the first partition, one or more processor operations (e.g., processor operations 222, etc.) based at least in part on the first data to generate second data (e.g., (K+1)th result data 118, etc.), wherein the one or more processor operations are executed asynchronously with respect to at least one of the second partition and a third partition (e.g., (K+2)th partition 114, etc.) of the computing system. In some instances, example method 400 at 404 can include using one or more systems or performing one or more activities described with respect to FIGS. 1A-1C.

At 406, example method 400 can include synchronously sending, by the first partition, the second data to the third partition. In some instances, example method 400 at 406 can include using one or more systems or performing one or more activities described with respect to FIGS. 1A-1C.

FIG. 5 is a block diagram of an example processor device 501 according to example implementations of aspects of the present disclosure. The processor device 501 can include one or more functional units 502; one or more communication units 503; one or more control units 504 (e.g., instruction control unit(s) 514, etc.); one or more timing or synchronization units 505; or other components. In some instances, functional unit(s) 502 of the processor device 501 can include one or more of: arithmetic functional unit(s) 506; memory functional unit(s) 507; tensor functional unit(s) 508 (e.g., matrix functional unit(s) 509, vector functional unit(s) 510, etc.), permute or routing functional units 511, or other functional units 517. Communication unit(s) 503 can include, for example, one or more of chip-to-chip communication link(s) 512, peripheral component interconnect express 513 components, or other communication unit(s) 503. Timing and synchronization units 505 can include, for example, one or more hardware-aligned counters 515, one or more software-aligned counters 516, or other timing or synchronization components.

A processor device 501 can include various types of processor architectures. In some instances, a processor device 501 can include a single-core or multi-core processor device 501. In some instances, a processor device 501 can include an integrated circuit located on a single die or a processor device 501 distributed over multiple dies connected together (e.g., directly connected such as via face-to-face connection, indirectly connected such as via one or more interposers, etc.). In some instances, a processor device 501 can include one or more of: one or more field-programmable gate arrays (FPGAs); one or more application-specific integrated circuits (ASICs), such as ASICs for machine-learning inference, matrix multiplication, floating-point operations, or the like; one or more graphics processor units (GPUs); one or more tensor processing devices; or other processor type. In some instances, a processor device 501 can include a deterministic processor device or a non-deterministic processor device (e.g., processor device configured to operate according to a deterministic or non-deterministic timing, etc.). In some instances, a processor device 501 can include a processor device having a plurality of dedicated special-purpose functional units, or a processor device having one or more general-purpose functional units (e.g., multi-core processor having a plurality of general-purpose processor cores, etc.). For example, in some instances, a processor device 501 can include a single-core processor device 501 having a plurality of special-purpose functional units 502 having distinct functions, such as functional units 502 having distinct instruction set architectures.

In some instances, a processor device 501 can include a deterministic processor device. A deterministic processor device can include, for example, a processor device configured to perform a plurality of operations according to a predetermined order, such as a predetermined program order defined by a compiler. In some instances, a deterministic processor device can include a processor device configured to perform a plurality of operations according to a predetermined timing or according to a predetermined temporal relationship between operations. For example, in some instances, a deterministic processor can include a processor configured to receive one or more computer-executable instructions (e.g., compiled instructions, etc.) comprising timing data; and execute the instruction(s) according to a predetermined time or predetermined temporal relationship indicated by the timing data. Timing data can include, for example, one or more of: data indicative of a clock cycle on which to execute a particular operation; data indicative of a temporal relationship between one or more first operations and one or more second operations, such as data indicative of a number of clock cycles to pause after a first operation (e.g., data transfer operation, instruction transfer operation, floating-point operation, etc.) is completed before performing a second operation (e.g., floating-point operation, tensor processing operation, etc.); data indicative of one or more operations or instructions configured to have an effect on a timing of operations, such as data indicative of one or more no-operation (NOP) operations or sleep operations, such as a repeated-NOP instruction to cause a functional unit 502 or other component of a processor device 501 to remain idle for a predetermined number of clock cycles; or other timing data.

In some instances, a deterministic processor device can include a processor device configured to receive, from a compiler, a set of computer-executable instructions controlling a timing of a plurality of operations associated with the computer-executable instructions; and perform the plurality of operations according to the timing. For example, in some instances, a deterministic processor device can include a processor device configured to receive a compiled program configured to cause, for each respective operation of a plurality of operations (e.g., arithmetic operations such as floating-point operations, tensor operations, etc.) to be performed on one or more respective data operands (e.g., numerical operands such as machine-learning model parameters, activation values, etc.), an instruction associated with the respective operation to intersect with the respective data operand at a predetermined time instant (e.g., clock cycle, clock cycle offset relative to an initial clock cycle, etc.) defined in the compiled program. In some instances, a deterministic processor can include a processor device having one or more components (e.g., functional unit(s) 502, communication unit(s) 503, etc.) having an instruction set architecture comprising instructions to control a timing of one or more operations of the one or more components.

In some instances, a deterministic processor device 501 can include a processor device configured to route data between functional units 502 of the processor device 501 according to a predetermined timing, predetermined routing or pathing, or both. For example, in some instances, a deterministic processor device 501 can include a processor device configured to receive compiled instructions comprising data indicative of one or more data transfers operations to be performed according to one or more predetermined routes determined by a compiler, according to one or more predetermined timing values defined by the compiler, or both. In this manner, for instance, a deterministic processor device 501 can enable a compiler to perform compile-time load balancing for a plurality of data paths, and can execute a plurality of runtime data transfers according to the compile-time load balancing.

In some instances, a deterministic processor device 501 can include a processor that lacks one or more non-deterministic components that may be commonplace among non-deterministic processor devices, such as branch prediction units, tiered or hierarchical cache devices, runtime load balancing, or other sources of runtime non-determinism (e.g., non-deterministic timing of operations, non-deterministic choice of operations such as non-deterministic routing of data, etc.). For example, in some instances, a processor device 501 can lack any branch prediction components, and can be configured to execute every operation of a compiled program according to a predetermined program order. As another example, in some instances, one or more memory functional units 507 can lack a cache hierarchy or lack any non-deterministic memory component(s). For example, in some instances, one or more memory functional units 507 can be configured to operate deterministically, such as according to a predetermined timing defined by a compiler. For example, in some instances, one or more memory functional units 507 can be configured to perform one or more read operations at one or more times predetermined by a compiler; perform one or more write operations at one or more times predetermined by the compiler; perform one or more refresh operations at one or more times predetermined by the compiler, such that the compiler can have explicit control over a refresh timing of the memory functional unit(s) 507; or the like. For example, in some instances, the compiler can compile a program or other executable into a set of deterministic operations that can be executed by the functional unit(s) 502 at known times specified by a deterministic schedule.

However, although a deterministic processor device 501 can lack some common sources of non-determinism, in some instances, a deterministic processor device 501 can include or interact with one or more non-deterministic components or devices without deviating from the scope of the present disclosure. As a non-limiting illustrative example, in some instances, a deterministic processor device 501 can include a PCIe 513 component configured to perform external input/output (I/O) operations, which can in some instances include input/output operations having a non-deterministic timing (e.g., I/O operations using a non-deterministic PCIe 513 device; I/O operations receiving input from non-deterministic external device(s); etc.). In some instances, a deterministic processor device 501 can interact with non-deterministic component(s) or device(s) (e.g. components or devices internal or external to the processor, etc.), while maintaining deterministic operation of the remaining components of the processor device 501 by designating one or more predetermined time windows to interact with the non-deterministic component(s) in a deterministic manner. For example, in some instances, a processor device 501 can be configured to check, at each of a plurality of predetermined times, whether one or more inputs (e.g., inference request(s), etc.) has been received via a PCIe device 513; and, if the processor device 501 determines that an input has been received, to process the input (e.g., write the input to a designated memory location or region, etc.) according to a predetermined timing or predetermined set of instructions (e.g., according to a set of operations configured to fit within a predetermined time window reserved for non-deterministic external I/O operations, etc.).

In some instances, a processor device 501 can include a processor device configured for single-instruction multiple-data (SIMD) operation. For example, in some instances, a processor device 501 can be configured to receive one or more computer-executable instructions that are each indicative of an operation to be performed on a plurality of operands, such as a vector of numerical operands; a tensor of numerical operands; or the like. In some instances, a SIMD processor device can include a processor device configured to provide a single instruction to a plurality of functional units 502 (e.g., adjacent functional units 502 arranged in a functional region, etc.) to cause each respective functional unit 502 of the plurality of functional units 502 to execute the instruction on one or more distinct operands provided to the respective functional unit 502 (e.g., routed to the respective functional unit 502 according to a predetermined compiler-defined routing, etc.).

In some instances, a processor device 501 can include a single-core processor device, or a processor device configured to operate as a single-core device (e.g., flexible-operation processor device having two hemispheres that can be operated in series as a single-core device or in parallel as a multi-core device, etc.). For example, in some instances, a single-core processor device can include a processor device configured to receive a single set of instructions (e.g., compiled instructions, etc.) and to execute, in a serial or pipelined fashion using one or more functional units 502, a set of operations defined by the single set of instructions. For example, in some instances, a single-core processor device 501 can include a processor device configured to obtain (e.g., receive, retrieve, etc.) one or more instructions (e.g., SIMD instructions, etc.) indicative of a plurality of operations (e.g., plurality of SIMD operations, etc.) to be performed on one or more operands; and perform, in series using a plurality of functional units 502, the plurality of operations (e.g., SIMD operations wherein each operation is a multiple-data operation, etc.) on the one or more operands.

Functional unit(s) 502 can include, for example, one or more components (e.g., integrated circuit components, etc.) configured to perform operations on one or more operands (e.g., data operands, etc.). In some instances, functional unit(s) 502 can include deterministic functional units 502, such as deterministic functional units configured to perform one or more operations in a predetermined program order, according to a predetermined timing or temporal relationship, or the like. In some instances, a set of functional units 502 can include a plurality of dedicated or special-purpose functional units 502, such as distinct functional units 502 having distinct functions or sets of functions (e.g., limited or specialized function sets, etc.). In some instances, functional unit(s) 502 can include functional units configured to perform multiple operations per instruction for at least some instructions, such as single-instruction multiple-data (SIMD) functional unit(s) 502, and/or functional unit(s) 502 configured to process instruction(s) directed to multiple computing operations (e.g., multiple repetitions of a single type of operation, pipeline of multiple different operations, etc.).

In some instances, a set of dedicated functional unit(s) 502 can include distinct dedicated functional units 502 for each of a plurality of steps in a machine-learning inference pipeline, such as a distinct dedicated functional unit for each component of a category or type of machine-learning model layer (e.g., convolutional layer, attention layer, fully connected layer, etc.). For example, in some instances, a set of dedicated functional units 502 for implementing a fully connected layer of a machine-learning model can include one or more matrix functional units 509 for performing matrix multiplication between a parameter tensor (e.g., weight matrix, etc.) and a tensor (e.g., vector, etc.) of input values to the fully connected layer, and one or more vector functional units 510 for performing an activation function of the fully connected layer. As another example, in some instances, a set of dedicated functional units 502 for implementing a convolutional layer of a machine-learning model can include one or more permute/routing functional units 511 configured to perform one or more data reshaping operations corresponding to one or more convolutions (e.g., two-dimensional convolutions, one-dimensional convolutions, etc.); and one or more other functional units 502 (e.g., matrix functional unit(s) 509, vector functional unit(s) 510, etc.) for performing additional operations associated with a convolutional layer or convolutional neural network (e.g., matrix multiplication, pooling, activation functions, etc.).

In some instances, a plurality of dedicated functional units 502 can include a first functional unit 502 configured to perform a set of operations that is different (e.g., completely disjoint from or partially overlapping, etc.) from a second set of operations associated with a second functional unit 502. In some instances, a plurality of special-purpose or dedicated functional units 502 can have a plurality of distinct instruction set architectures, such as limited or special-purpose instruction set architectures each supporting a limited or special-purpose set of operations. As a non-limiting illustrative example, in some instances, a set of dedicated functional units 502 can include one or more of: a matrix functional unit 509 configured to perform a first set of matrix operations (e.g., matrix multiplication operations, etc.); a vector functional unit 510 configured to perform a set of vector operations different from the matrix operations (e.g., activation function operations such as rectified linear unit (ReLU), sigmoidal, softmax, or other activation function operations; normalization operations; etc.); a permute/routing functional unit 511 configured to perform one or more data routing, data permutation, or data reshaping functions (e.g., tensor permutation or reshaping, etc.) different from the matrix operation(s) and different from the vector operation(s); or other dedicated functional unit(s) 502. Other examples are possible.

In some instances, functional unit(s) 502 can include functional units organized into functional regions of a processor die, such as compact functional regions configured to facilitate low-latency propagation of instructions or operands within a functional unit 502 or between adjacent functional units 502. As a non-limiting illustrative example, in some instances, one or more functional units 502 can be organized into functional slices along a first axis of a processor die, thereby enabling low-latency propagation of one or more instructions along the axis, low-latency propagation of operand data along a second axis, or the like.

In some instances, functional unit(s) 502 or functional region(s) can be geographically organized on a processor die to reduce (e.g., minimize or nearly minimize; reduce relative to a random arrangement or relative to a conventional multi-core central processing unit or conventional graphics processing unit, etc.) a communication cost (e.g., latency cost, power cost, communication distance, etc.) associated with one or more computational pipelines, such as machine-learning inference pipelines. For example, in some instances, one or more functional units 502 or functional regions of a processor device 501 for performing a sequentially first operation in a computational pipeline can be geographically close to one or more functional units 502 for performing a sequentially second operation in the computational pipeline. Example computational pipelines can include, for example, inference pipelines associated with common machine-learning model, layer, or head architectures, such as convolutional architectures; attention architectures; fully connected layer architectures; selective structured state space machine architectures; gating architectures (e.g., long short-term memory, etc.); or another machine learning architecture.

In some instances, functional unit(s) 502 can include functional units configured to perform multiple operations per instruction for at least some instructions, such as single-instruction multiple-data (SIMD) functional unit(s) 502 or functional units 502 configured to operate without necessarily receiving explicit instructions for each operation. For example, functional unit(s) 502 configured to operate without necessarily receiving explicit instructions for each operation can include one or more of: functional unit(s) 502 configured to receive intermittent instructions and perform multiple operations per instruction (e.g., repeated single operation, pipeline of multiple different operations, etc.); functional unit(s) 502 configured to operate without instructions according to a default operation; or the like. In this manner, for instance, an amount of communication required to provide instructions to the functional units 502 can be reduced, and operation of the processor device 501 can in some instances be simplified compared to some alternative implementations.

For example, in some instances, a SIMD functional unit 502 can include a tensor functional unit 508 configured to execute an instruction on a plurality of numerical values, such as a vector or matrix of numerical values. For example, in some instances, a tensor functional unit 508 can be configured to receive an instruction; and process, according to the instruction, a tensor (e.g., one-dimensional vector tensor, two-dimensional matrix tensor, etc.) comprising a plurality of numerical values (e.g., dozens of numerical values per instruction, such as hundreds, etc.). In some instances, a tensor functional unit 508 can be configured to process some or all of a plurality of values simultaneously, or to execute a single-instruction multiple-data instruction according to a staggered timing.

As another example, in some instances, a functional unit 502 configured to operate based on intermittent instructions can include a functional unit 502 configured to repeat one or more operations, such as a functional unit 502 configured to continue performing a given operation (e.g., an operation associated with a most recently received instruction, etc.) periodically (e.g., at every clock cycle; at every Nth clock cycle; etc.) for some amount of time (e.g., indefinitely, for a finite period of time such as a time period defined by a previously received instruction, etc.) in the absence of explicit instructions. In some instances, a functional unit 502 can include a functional unit 502 configured to receive and execute one or more repetition instructions (e.g., having an instruction set architecture comprising one or more repetition instructions, etc.). A repetition instruction can include, for example, an instruction to cause the functional unit 502 to repeat (e.g., repeat at every clock cycle; at every Nth clock cycle, where N can be a parameter of the instruction; etc.) a previous instruction or set of instructions a number of times specified by the instruction; an instruction indicative of an operation to be repeated (e.g., arithmetic operation, matrix operation, vector operation, etc.), the instruction having a repetition parameter indicating a number of times to repeat the operation; or the like. In some instances, a repetition instruction can include one or more offset parameters, such as a time offset parameter (e.g., number of cycles to wait between repetitions, etc.), location offset parameter indicative of a distance between consecutive locations (e.g., functional unit 502 location, memory location, data path location, etc.) associated with a repeated operation, or other offset parameter.

As another example, in some instances, a functional unit 502 can include a functional unit 502 configured to receive a single instruction indicative of multiple distinct operations to be performed on a single operand or set of operands, such as a multiply-accumulate (MACC) instruction or matrix multiplication instruction indicative of one or more multiply operations and one or more accumulate operations to be performed on one or more outputs of the multiply operation(s). In some instances, a functional unit 502 can include a pipelined hardware architecture (e.g., systolic array pipelined hardware, deterministic streaming hardware, etc.) configured to provide (e.g., directly; indirectly via one or more buffers, registers, or other memory components; etc.) an output of one or more first hardware devices (e.g., floating-point units, etc.) for performing earlier (e.g., sequentially first, etc.) operations of a multi-operation instruction to an input of one or more second hardware devices for performing later (e.g., sequentially second or last, etc.) operations of the multi-operation instruction. In some instances, a pipelined hardware architecture of a functional unit 502 can include a geographically compact architecture, wherein a plurality of components for performing a multi-operation instruction can be adjacent or otherwise close together on a processor die.

An arithmetic functional unit 506 can include, for example, one or more functional units 502 for performing various arithmetic operations, such as floating-point operations, integer operations, or quantized operations; simple operations (e.g., add, multiply, format conversion, etc.) or complex/combined operations (e.g., multiply-accumulate, etc.); single-operand operations or multi-operand operations (e.g., tensor operations, etc.); or other arithmetic operations. In some instances, an arithmetic functional unit 506 can be a tensor functional unit 508 or component thereof, or have one or more properties described below with respect to tensor functional unit(s) 508.

A memory functional unit 507 can include, for example, one or more functional units 502 for reading, writing, or storing various kinds of data, such as operand data, instruction data, or other data. Data storage can include, for example, temporary storage of one-time-use or ephemeral values (e.g., computed operand values, etc.), longer-term storage of values to be reused (e.g., machine-learning model weights, compiled computer-executable instructions, etc.), or other storage. In some instances, a memory functional unit 507 can include one or more low-latency, high-bandwidth, or otherwise rapidly accessible memory devices, such as random access memory (RAM) devices (e.g., static random access memory (SRAM), high-bandwidth memory (HBM), dynamic random access memory (DRAM), etc.), registers, or other low-latency devices.

In some instances, one or more memory functional units 507 can be configured to share a global address space accessible to a plurality of functional units 502. For example, in some instances, a global address space can include all memory locations available to the processor device 501 (e.g., including any external memory modules, etc.), such that any functional unit 502 of the processor device 501 can obtain (e.g., receive at a predetermined time defined by the compiler, such as without requiring the functional unit 502 to output any request for the data obtained). In some instances, a set of memory functional unit(s) 507 can include, or a processor device 501 can have access to, one or more internal (e.g., on-chip) memory functional units 507; one or more external (e.g., off-chip, near-compute, etc.) memory units; or both.

A tensor processing unit 508 can include, for example, a functional unit 502 to perform one or more operations (e.g., arithmetic operations such as tensor multiplication, elementwise multiplication, normalization, activation function operations, etc.) on one or more tensors (e.g., matrices, vectors, etc.). In some instances, a tensor processing unit 508 can include a matrix functional unit 509; a vector functional unit 510; or another functional unit.

A matrix processing unit 509 can include, for example, a functional unit 502 configured to perform one or more operations on a matrix (e.g., two-dimensional matrix, flattened matrix, etc.) of operands (e.g., numerical values such as floating-point values, etc.). In some instances, a matrix processing unit 509 can include a functional unit 502 configured to perform matrix multiplication or other matrix operations.

A vector processing unit 510 can include, for example, a functional unit 502 configured to perform one or more operations on a vector (e.g., one-dimensional vector, flattened tensor, etc.) of operands (e.g., floating-point numerical values, etc.). In some instances, a vector processing unit 510 can include a functional unit 502 configured to perform one or more of: one or more activation function operations (e.g., sigmoidal or logistic activation function, linear unit activation function such as rectified linear unit (ReLU), softmax activation function, etc.), one or more normalization operations (e.g., L2 normalization, etc.), one or more combining operations (e.g., attention-based combining, etc.) to combine a set (e.g., pair, trio, etc.) of vectors, one or more constituent operations configured to be combined to support a class of related operations (e.g., class or category of normalization operations, class or category of activation function operations, etc.), or the like.

A permute/routing functional unit 511 can include, for example, a functional unit 502 configured to perform one or more data permuting or data routing operations. In some instances, a data permuting operation can include one or more swap or reordering operations configured to reorder data in an ordered format (e.g., vector format or other tensor format; ordered arrangement of registers, signal lines, or other hardware units; etc.), such as without changing a shape (e.g., length, width, number of dimensions, etc.) of the ordered format.

Example reordering operations can include, for example, rotation or translation operations; arbitrary reordering operations defined by one or more reordering maps such as a gather map; or other reordering operations. In some instances, a data permuting operation can include a reshaping operation, such as a reshaping operation changing a number of dimensions of a data structure (e.g., tensor, hardware devices corresponding to a tensor, etc.), changing a size of one or more dimensions of the data structure, or the like. As a non-limiting illustrative example, in some instances, a reshaping operation can include a tensor flattening operation to convert a multi-dimensional tensor into a one-dimensional data structure (e.g., vector, hardware configuration corresponding to a vector, one-dimensional data stream corresponding to a vector, etc.). As another example, in some instances, a reshaping operation can include an expansion or duplication operation, such as a reshaping operation to generate an expanded convolutional kernel to implement a filter component of a convolutional neural network. In some instances, a routing operation can include a permuting operation to change an ordering of operands input to one or more fixed or predetermined data paths, or another routing operation (e.g., switching operation; pair of operations comprising a send and a receive; etc.). In some instances, a permuting operation can include a routing operation to change a routing of operands to hardware having a fixed or predetermined input order.

In some instances, a memory functional unit 507; a tensor, matrix, or vector functional unit 508, 509, 510; or a permute/routing functional unit 511 can be or include a deterministic functional unit 502 configured to execute instruction(s) at a predetermined time defined by a compiler; a single-instruction multiple-operation functional unit 502 configured to perform a plurality of operations based on one instruction; or have any other property described herein with respect to functional unit(s) 502.

Communication units 503 can include various components for performing communication operations (e.g., input, output, etc.) between the processor device 501 and other devices (e.g., processor devices, computing devices, external memory devices, etc.) or components, or within the processor device 501. In some instances, communication units 503 can include deterministic communication units (e.g., communication units performing operations according to a predetermined program order, timing, temporal relationship, or other predetermined property, etc.), non-deterministic communication units (e.g., communication units having non-deterministic timing properties, communication units configured to communicate with non-deterministic external devices, etc.), or both. For example, in some instances, a deterministic processor device 501 can include a plurality of deterministic chip-to-chip communication links 512 configured to communicate with other deterministic processor devices 501 (e.g., using deterministic communication operations having a predetermined timing, communication path, or other property), along with one or more PCIe components 513 configured to interact with one or more non-deterministic components. In some instances, communication units 503 can include or have access to various components, such as serializer-deserializer (SerDes) units configured to serialize data to be output or deserialize data received as input; communication ports, connections, interface units, or the like; communication lines (e.g., electrically conductive signal traces, electrically conductive wires, optical fibers, cables, etc.); routing or data permutation components (e.g., internal routing or permutation components such as switching components; external components coupled to the processor device 501 such as routers, repeaters, switches, panels, or the like); or other components configured to facilitate one or more communication operations.

Chip-to-chip communication units 512 can include, for example, any device or component for communicating with another processor device (e.g., processor device 501, etc.), such as one or more serializer-deserializer units, one or more communication channels (e.g., signal lines, etc.), one or more connection components (e.g., ports, pins, connection pads, etc.), or the like. In some instances, a processor 501 can include a plurality of chip-to-chip communication ports to facilitate direct communication with a plurality (e.g., four, eight, sixteen, etc.) of other chips, such as according to a high-radix chip-to-chip communication topology (e.g., dragonfly topology, hyperX topology, etc.), such as a topology having greater than or equal to eight chip-to-chip communication links per processor device 501. In some instances, chip-to-chip communication units 512 can include units configured to communicate with processor devices that are geographically close to or far away from the processor device 501 (e.g., in a same or different compute node as the processor device 501; in a same or different rack; etc.). In some instances, chip-to-chip communication units 512 can include connections to a plurality of distinct chips, a plurality of connections to a single chip, or both. In some instances, chip-to-chip communication units 512 can include chip-to-chip communication units 512 associated with one or more bidirectional communication channels, one or more unidirectional communication channels, or both. In some instances, chip-to-chip communication units 512 can include deterministic communication units configured to perform chip-to-chip communication operations (e.g., send operation, receive operation, etc.) at one or more times predetermined by a compiler; deterministic communication units having a known or deterministic timing for one or more data transfer operations; or the like. In some instances, one or more timing units 505 can be used to provide synchronization for one or more processor devices 501 to facilitate deterministic-timing communication between chips.

A peripheral component interconnect express (PCIe) component 513 can include, for example, a communication device configured to facilitate communication between a processor device 501 and one or more other devices (e.g., computing devices; processor devices; data storage devices; auxiliary devices; etc.). In some instances, a PCIe unit 513 can include a communication system conforming to one or more PCIe communication standards (e.g., PCIe 6.0, PCIe 7.0, etc.). Although FIG. 5 depicts a PCIe unit 513, other communication units or communication standards can be used without deviating from the scope of the present disclosure. In some instances, a processor device 501 can include a deterministic processor device 501 configured to communicate non-deterministically via the PCIe unit 513 while maintaining determinism in the functional unit(s) 502 of the processor device 501 (e.g., according to methods described above).

In some instances, control unit(s) 504 can include one or more devices for controlling one or more operations of the functional unit(s) 502, such as device(s) configured to supply one or more control signals (e.g., assembly code or machine code instructions; switching signals, multiplexer selection signals, etc.) to one or more functional unit(s) 502.

In some instances, control unit(s) 504 can include one or more instruction control unit(s) 514 configured to supply computer-executable instruction(s) to one or more functional units. In some instances, an instruction control unit 514 can include a deterministic instruction control unit 514 configured to supply instruction(s) to the functional unit(s) 502 according to a predefined program order determined by the compiler; supply instruction(s) at one or more predefined times (e.g., clock cycles, etc.); or the like. In some instances, an instruction control unit 514 can include hardware configured to fetch (e.g., prefetch, etc.) instruction(s) from memory at a first time (e.g., before the instructions are needed; during a time of off-peak memory usage; at a time predetermined by a compiler; etc.) and provide corresponding instruction(s) to one or more functional unit(s) 502 at a second time (e.g., second time predetermined by the compiler, etc.)

In some instances, instruction(s) provided to a functional unit 502 by an instruction control unit 514 can be the same as or different from a corresponding instruction received by the instruction control unit 514. For example, in some instances, an instruction control unit 514 can include a unit configured to translate one or more compiled instructions (e.g., instructions in a first computing language or format output by a compiler, etc.) to one or more control signals (e.g., instructions in a second language or format; other control signals such as multiplexer selection signals or the like). In some instances, translating compiled instructions can include translating a memory-efficient stored instruction to a plurality of control signals that may include a greater data volume than the memory-efficient stored instruction. For example, in some instances, translating compiled instructions can include retrieving, from a memory functional unit 507, a compiled instruction; and providing, based on the compiled instruction, a plurality of control signals to one or more (e.g., a plurality of) functional units 502 over one or more (e.g., a plurality of) clock cycles. In some instances, a memory-efficient stored instruction can include a multi-operation instruction associated with a plurality of related operations (e.g., operations of a machine-learning model layer such as matrix multiplication, activation functions, convolution, attention, or the like), and the translated control signals can include a plurality of control signals (e.g., lower-level instructions, etc.) for executing the multi-operation instruction. In some instances, an instruction control unit 514 can include hardware configured to receive an instruction comprising one or more timing parameters (e.g., delay amounts, etc.) or repetition parameters, and output control signal(s) to the functional unit(s) 502 to cause the functional units to perform operations according to the timing or repetition parameters (e.g., at a predetermined clock cycle defined by a compiler, etc.). In some instances, the instruction control unit 514 can control a timing or a number of repetitions of the functional unit(s) 502 by sending control signals comprising timing or repetition data, or by sending raw control signals at a specific time or plurality of times configured to cause the functional unit(s) 502 to perform operations according to one or more timing or repetition parameters.

In some instances, timing and synchronization units 505 can include various components configured to perform synchronization operations, such as operations to track or communicate time data (e.g., current clock cycle data, etc.) to one or more functional units 502 or other components of a processor device 501. In some instances, timing and synchronization units 505 can include one or more of: one or more hardware-aligned counters 515, one or more software-aligned counters 516, or other timing or synchronization component.

Hardware aligned counters 515 may be used to establish a time base for electronic circuitry in each system, such as a clock, for example. Additionally, each system may include software aligned counters 516. Software aligned counters 516 may be synchronized, for example, based on one or more computer-executable instructions (e.g., compiled instructions determined by a compiler, etc.). Hardware aligned counters 515 and software aligned counters 516 may be implemented as digital counter circuits, for example, on each integrated circuit (e.g., each processor device 501 or each die thereof, etc.). For instance, hardware aligned counters 515 may be free-running digital counters (e.g., 8-bit counters) on a processor device 501 that are synchronized periodically. Similarly, software aligned counters 516 may be digital counters (e.g., 8-bit counters) that are synchronized based on timing markers triggered by one or more compiled programs.

In some instances, timing and synchronization units 505 can include one or more components 505 for internal synchronization of a plurality of components (e.g., functional units 502, etc.) of a processor device 501; one or more components 505 for external synchronization between a first processor device 501 and one or more other devices (e.g., a plurality of second processor devices 501, etc.); or both.

In some instances, synchronizing a first device (e.g., first processor device 501 or another device) with a second device (e.g., second processor device 501 or another device, etc.) can include, for example, synchronizing one or more hardware aligned counters 515 of the first processor device 501 with one or more hardware aligned counters of the second device. Synchronizing the hardware aligned counters 515 may occur periodically during the operation of each system and may occur at a higher frequency than synchronizing software counters 516, for example. Synchronizing hardware counters may include the first device sending a timing reference (e.g., timing bits representing a time stamp) to the second device over a communication channel (e.g., via chip-to-chip communication units 512, etc.). In some instances, a first system may send an 8-bit time stamp, for example. In such a scenario, a hardware counter 515 and software counter 516 of the first device may be maintained in sync locally. However, as the hardware counter 515 on a first device is synchronized to the hardware counter 515 on a second device, the software counter 516 on the second device may drift.

In some instances, software aligned counters 516 of a pair of devices can be synchronized by providing, in each of the devices (e.g., as part of a compiled program executed by the devices, etc.), one or more timing markers configured to be sequentially triggered (e.g., at predetermined positions in a compiled program corresponding to particular points of time or particular cycles). In some instances, timing markers in each device may be configured to trigger on the same cycle in each system. For example, a first program on a first device may trigger a timing marker on the same cycle as a second program on a second device when the devices'hardware aligned counters 515 are synchronized. In some instances, these timing markers may be used to synchronize software counters 516 of both devices. For example, in some instances, timing differences between the timing markers may correspond to a time difference indicative of a degree to which the two devices are out of synchronization, and synchronization can include adjusting a timing of one or more operations based on the time difference. For example, in some instances, a software aligned counter 516 can perform one or more delay operations at each of a plurality of timing markers, and a length of the delay can be adjusted based at least in part on a time difference between the first and second device at the timing marker. However, same-cycle timing is not required; for example, in some instances, a pair of timing markers may be offset by a known number of cycles, which may be compensated for during the synchronization process (e.g., by using different fixed delays, etc.).

In some instances, a timing difference (e.g., number of cycles, etc.) between timing markers may be constrained within a range. For example, a minimum time difference between timing markers in a first and second device may be based on a time to communicate information between the devices (e.g., a number of cycles greater than a message latency), and a maximum time difference between timing markers in the devices may be based on a tolerance of oscillators forming the time base on each system (e.g., if the time difference increases beyond a threshold for a given time base tolerance, it may become more difficult or impossible for the systems to synchronize for a given fixed delay). The minimum and maximum number of cycles may also be based on the size of a buffer (e.g., a first in first out (FIFO) memory) in each chip-to-chip communication circuit, for example.

In some instances, synchronizing hardware aligned counters 515 of a pair of devices can include sending, by a first device at a first time t₀, a timing reference; and receiving, at a second time t₁ by a second device, the timing reference. In some instances, the latency of such a transmission may be characterized and designed to be a known time delay Δt=t₁−t₀. In such instances, synchronizing the pair of devices can include setting, by the second device, a hardware aligned counter 515 to a value of (t₀+Δt) such that the hardware aligned counters 515 of both devices are synchronized.

In some instances, although the first and second devices can be architecturally similar (e.g., same) or different, synchronizing the devices can include, for example, assigning a first device as a designated sender device to send timing data, and designating a second device as a designated receiver device to receive timing data and adjust a timing of the receiver device's operations based on the timing data.

In some instances, software aligned counters 516 can be synchronized in a manner similar to synchronization of hardware aligned counters 515. For example, in some instances, a software aligned counter 516 can include or implement one or more timing triggers comprising one or more delays (e.g., no-operation (NOP) delays, etc.), wherein a plurality of devices are configured to perform a synchronized delay, such that one or more operations performed after the synchronized delay may be synchronized. For example, in some instances, a first device may send timing data to a second device at t0; and perform a predefined delay operation until t1. A second device may receive the timing data at (t0+Δt); and determine, based on the timing data, an amount of delay (e.g., number of clock cycles, etc.) to cause the second device to resume operations at t1.

In some instances, synchronization can include fine synchronization (e.g., as described above), coarse synchronization, or both. For example, during various points in operation, the first and second systems may be far out of sync. For example, during startup or after a restart (collectively, a “reset”), a set (e.g., pair, etc.) of devices may perform a coarse synchronization (e.g., using a 20-bit digital counter, etc.) to bring the time bases close enough so they can be maintained in alignment using the techniques described above (e.g., within a resolution of the hardware and software counters, such as 8 bits).

In some instances, synchronizing a number of devices greater than two can include performing similar operations with more than two devices, such as pairwise synchronizations at staggered times, such as pairwise synchronization of a processor device 501 with each of a plurality of neighbors in a chip-to-chip communication topology at a plurality of respective times; one-to-many (e.g., one-to-all, etc.) broadcasting of timing data; pairwise propagation of timing data between pairs of devices according to a propagation pattern or communication topology; or other mechanism for sending and receiving timing data and updating a timing of operations based on the timing data.

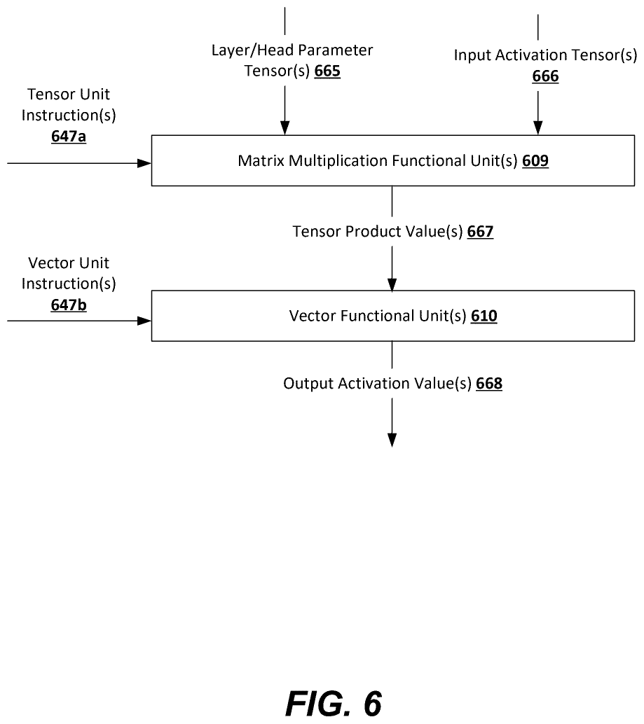

FIG. 6 is a block diagram of an example system for performing machine-learning inference according to example implementations of aspects of the present disclosure. One or more matrix multiplication functional units 609 can receive one or more layer/head parameter tensors 665 indicative of a plurality of parameters of a current machine-learning model layer, head, or other component currently being executed; one or more input activation tensors 666 indicative of a plurality of input values to the current layer/head; and one or more tensor unit instructions 647a to cause the matrix multiplication functional unit(s) 609 to perform tensor multiplication of the input activation tensor(s) 666 and layer/head parameter tensor(s) 665 to determine one or more tensor product values 667. One or more vector functional units 610 can receive the tensor product values 667 and one or more vector unit instructions 647b to cause the vector functional unit(s) 610 to execute one or more activation functions based on the tensor product values 667 to generate a plurality of output activation values 668 to be provided to a next layer, head, or other component of a machine-learning model being executed.

In some instances, a matrix multiplication functional unit 609 can be, comprise, be comprised by, or otherwise share one or more properties with a matrix functional unit 509. For example, in some instances, a matrix multiplication functional unit 609 can have any property described herein with respect to a matrix functional unit 509, and vice versa.

In some instances, a vector functional unit 610 can be, comprise, be comprised by, or otherwise share one or more properties with a vector functional unit 510. For example, in some instances, a vector functional unit 610 can have any property described herein with respect to a vector functional unit 510, and vice versa.

In some instances, tensor unit instruction(s) 647a can include instructions provided to a matrix multiplication functional unit 609 by an instruction control unit 514 based at least in part on one or more compiled inference instructions. Similarly, in some instances, vector unit instruction(s) 647b can include instruction(s) provided to a vector functional unit 610 by an instruction control unit 514 based at least in part on one or more compiled inference instructions. In some instances, tensor unit instruction(s) 647a can include instruction(s) requesting one or more matrix multiplication operations. In some instances, vector unit instruction(s) 647b can include instruction(s) requesting one or more activation function operations, such as rectified linear unit (ReLU), sigmoidal (e.g., logistic, etc.), softmax, or other activation function operation. In some instances, an instruction 647a, b can include an instruction comprising repetition or timing data, such as an instruction comprising data indicative of a number of clock cycles to wait between operations (e.g., between repetitions of a repeated operation, etc.); data indicative of a number of times to repeat an operation; or the like.

In some instances, layer/head parameter tensor(s) 665 can include one or more parameters of a machine-learning model, such as parameters comprising all or part of a layer, head, or other component of the machine-learning model. In some instances, layer/head parameter tensor(s) 665 can include tensor data (e.g., two-dimensional matrix data, etc.) comprising a plurality of numerical parameter values, such as floating-point values (e.g., eight-bit, sixteen-bit, 32-bit, four-bit, or another precision of floating-point values, etc.), integer values (e.g., eight-bit, sixteen-bit, 32-bit, four-bit, or another precision of integer values, etc.), quantized values, or other data type.

In some instances, input activation tensor(s) 666 can include one or more inputs to a layer, head, or other component of a machine-learning model, such as an output of a tokenizer or other preprocessor; an output of a previous layer or head of the machine-learning model; a raw input value included in an inference request; or other input value. In some instances, input activation tensor(s) 666 can include tensor data (e.g., one-dimensional vector data, etc.) comprising a plurality of numerical activation values, such as floating-point values (e.g., eight-bit, sixteen-bit, 32-bit, four-bit, or another precision of floating-point values, etc.), integer values (e.g., eight-bit, sixteen-bit, 32-bit, four-bit, or another precision of integer values, etc.), quantized values, or other data type.

In some instances, layer/head parameter tensor(s) 665 or input activation tensor(s) 666 can include one or more reshaped (e.g., expanded, flattened, etc.) tensors based on one or more raw parameter sets or input activations. For example, in some instances, a machine-learning model can include one or more convolutional layers each comprising one or more convolutional kernels, and machine-learning inference can include one or more reshaping operations to implement a corresponding convolution, such as a kernel expansion operation to generate an expanded convolutional kernel comprising multiple copies (e.g., rotated or permuted copies, unrotated copies, etc.) of the kernel, an input activation reshaping operation (e.g., flattening operation, etc.), or other preprocessing operation.

Tensor product value(s) 667 can include, for example, a tensor product (e.g., matrix product, etc.) of a layer/input parameter tensor 665 and an input activation tensor 666. Output activation value(s) 668 can include, for example, an output of one or more operation(s) performed by the vector functional unit(s) 610 on the tensor product value(s) 667, such as one or more activation function operations (e.g., ReLU, etc.); one or more normalization operations; one or more combining or mixing operations (e.g., attention-based mixing; gate-based mixing; etc.).

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c),. (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A method comprising:
synchronously receiving, by a first partition of a distributed computing system, first data from a second partition of the distributed computing system;
executing, by the first partition, one or more processor operations based at least in part on the first data to generate second data; and
synchronously sending, by the first partition, the second data to a third partition of the distributed computing system;
wherein the one or more processor operations are executed asynchronously with respect to at least one of the second partition and the third partition.

2. The method of claim 1, wherein the first partition comprises a synchronized partition comprising a plurality of computing devices, and wherein the one or more processor operations comprise synchronized processor operations that are synchronous with respect to the first partition.

3. The method of claim 1, wherein synchronously receiving the first data comprises:
synchronizing, by the first partition based at least in part on one or more timing messages received from the second partition, an operation of the first partition with a clock of the second partition; and
processing, by the first partition based at least in part on a predetermined time at which the second partition is to begin transmitting the first data, a data transmission comprising the first data.

4. The method of claim 3, further comprising:
receiving, by the first partition from the second partition, a notification indicative of the predetermined time at which the second partition will begin transmitting the first data;
wherein processing the data transmission comprises processing based at least in part on the notification.

5. The method of claim 1, wherein synchronously transmitting the second data comprises:
synchronizing, by the first partition based at least in part on one or more timing messages received from the third partition, an operation of the first partition with a clock of the third partition; and
transmitting, by the first partition to the second partition at a predetermined time that is known by the second partition, a data transmission comprising the second data.

6. The method of claim 1, further comprising:
executing, by the first partition, one or more second processor operations based at least in part on third data, wherein the one or more second processor operations are executed while the third partition is executing one or more third processor operations based at least in part on the second data.

7. The method of claim 1, wherein the one or more processor operations are part of a plurality of sequential operations performed in serial by a plurality of partitions of the distributed computing system.

8. The method of claim 7, wherein the plurality of sequential operations comprises a plurality of layers of a machine-learning model.

9. The method of claim 7, wherein a data flow graph of the plurality of sequential operations comprises a data flow path having a path length greater than five partitions of the plurality of partitions.

10. The method of claim 7, wherein the one or more processor operations comprise a plurality of operations executed in parallel by a plurality of processor devices of the first partition.

11. The method of claim 1, further comprising, for each of a plurality of consecutive iterations:
synchronously receiving, by the first partition from the second partition, third data;
executing, by the first partition, the one or more processor operations on the third data to generate fourth data; and
synchronously sending, by the first partition to the third partition, the fourth data;
wherein executing the one or more processor operations at different iterations comprises executing one or more same processor operations on different data.

12. The method of claim 11, wherein the one or more processor operations comprise performing a tensor multiplication based on the third data and one or more parameter values, and wherein the one or more parameter values are unchanged at each of the plurality of consecutive iterations.

13. The method of claim 1, further comprising:
receiving, by the first partition from the second partition, a first notification indicative of a predetermined time at which the second partition will begin transmitting third data; and
providing, by the first partition to the second partition, a second notification indicating that the first partition will not be ready to receive the third data at the predetermined time.

14. The method of claim 1, further comprising:
outputting, by the first partition via an asynchronous communication link, computational state data to an external memory device to cause the external memory device to store a cached computational state associated with the one or more processor operations.

15. The method of claim 1, wherein the first partition comprises a plurality of deterministic computing devices configured to execute the one or more processor operations at one or more predetermined times determined at a compile time by a compiler.

16. The method of claim 1, further comprising:
receiving, by the first partition from the second partition, a program identifier indicative of the one or more processor operations; and
retrieving, by the first partition based on the program identifier, program data associated with the program identifier from one or more memory devices of the first partition.

17. A computing system comprising:
a plurality of synchronized partitions, each synchronized partition comprising a plurality of computing devices; and
one or more non-transitory computer-readable media storing instructions that are executable by one or more processors to cause each respective partition of the plurality of synchronized partitions to perform operations, the operations comprising:
for each of one or more iterations:
synchronously receiving, from a preceding synchronized partition of the computing system, operand data generated by the preceding synchronized partition;
executing one or more processor operations based at least in part on the operand data to generate output data; and
synchronously transmitting, to a following synchronized partition of the computing system, the output data;
wherein the one or more processor operations are executed asynchronously with respect to at least one of the preceding synchronized partition and the following synchronized partition.

18. The computing system of claim 17, wherein the plurality of synchronized partitions comprises a plurality of intermediate-layer partitions, and further comprising one or more of:
an input-layer synchronized partition comprising one or more non-deterministic communication links configured to receive input data from an external source, wherein the input-layer synchronized partition is configured to provide output data to a first partition of the plurality of intermediate-layer partitions; and
an output-layer synchronized partition comprising one or more non-deterministic communication links configured to provide output data to an external destination, wherein the output-layer synchronized partition is configured to receive input data from a second partition of the plurality of intermediate-layer partitions.

19. The computing system of claim 17, wherein the computing system comprises a plurality of racks, and further comprising one or more inter-rack deterministic communication links configured to facilitate deterministic-timing communication between a first computing device of a first rack of the plurality of racks and a second computing device of a second rack of the plurality of racks.

20. One or more non-transitory computer-readable media storing instructions that are executable by one or more processors to cause a first synchronized partition of a computing system to perform operations, the operations comprising:
synchronously receiving first data from a second partition of the computing system;
executing one or more processor operations based at least in part on the first data to generate second data; and
synchronously sending the second data to a third partition of the computing system;
wherein the one or more processor operations are executed asynchronously with respect to at least one of the second partition and the third partition.
